(19) United States
(12) Patent Application Publication
(10) Pub. No.: US 2015/0205358 A1
(43) Pub. Date: Jul. 23, 2015

(54) Electronic Device with Touchless User Interface

(71) Applicant: Philip Scott Lyren, Bangkok (TH)

(72) Inventor: Philip Scott Lyren, Bangkok (TH)

(21) Appl. No.: 14/158,866

(22) Filed: Jan. 20, 2014

(51) Int. Cl. G06F 3/01; G06F 3/0487; G06F 3/0481

(52) U.S. Cl. CPC G06F 3/017; G06F 3/0481; G06F 3/0487

(57) ABSTRACT

An electronic device determines a tap from a finger of a user toward a surface of an electronic device while the surface is face-down and not visible to the user. A touchless user interface activates clicks on objects displayed with the electronic device.

### BACKGROUND

Handheld portable electronic devices, such as tablet computers, smartphones, and laptop computers, often have a display with a touchscreen. The touchscreen allows a user to control the electronic device by touching the display with one or more fingers.

When a user touches the display to control the electronic device, the hand or fingers of the user partially block a view of the display. Thus, while the user interacts with the electronic device, a portion of the display is not visible to the user.

### BRIEF DESCRIPTION OF THE DRAWINGS

FIG. 1 is a method to move a cursor along a display of an electronic device in accordance with an example embodiment.

FIG. 2 is a method to move a cursor on a display of an electronic device in response to repetitive movement of a finger in accordance with an example embodiment.

FIG. 3 is a method to perform a click and drag operation of an object on a display of an electronic device in response to motion of a finger along a Z-axis in accordance with an example embodiment.

FIG. 4 is a method to activate a click on a display of an electronic device from a surface that is not visible to a user in accordance with an example embodiment.

FIG. 5 is a method to execute an instruction upon determining an identity of a user of an electronic device in accordance with an example embodiment.

FIG. 6 is a method to activate and de-activate a touchless user interface of an electronic device in accordance with an example embodiment.

FIG. 7 is a method to execute an instruction based on determining a drawn shape through space adjacent an electronic device in accordance with an example embodiment.

FIG. 8 is a method to execute an instruction with an electronic device in response to motion of a finger and a thumb in accordance with an example embodiment.

FIG. 9 is a method to activate and to deactivate displays of an electronic device in response to determining movement of the electronic device and/or a user in accordance with an example embodiment.

FIG. 10 is a method to determine movement of a hand and/or finger(s) in a zone provided in space to control an electronic device with a touchless user interface in accordance with an example embodiment.

FIG. 11 is a method to display with a wearable electronic device a display of another electronic device and a zone to control the other electronic device with a touchless user interface in accordance with an example embodiment.

FIGS. 12A-12D illustrate an electronic device in which a user controls the electronic device through a touchless user interface with a hand and/or finger(s) in accordance with an example embodiment.

FIGS. 13A and 13B illustrate an electronic device in which a user controls the electronic device through a touchless user interface with a hand and/or finger(s) of a right hand while a left hand holds the electronic device in accordance with an example embodiment.

FIG. 14 illustrates an electronic device in which a user enters text on a display located on a front side or front surface through a touchless user interface from a back side or back surface in accordance with an example embodiment.

FIG. 15 illustrates an electronic device in which a user controls a pointing device located on a display with a finger and a thumb of a hand while the electronic device is positioned between the finger and the thumb in accordance with an example embodiment.

FIGS. 16A and 16B illustrate a computer system that uses a touchless user interface with a wearable electronic device to control a remote electronic device through a network that communicates with a server in accordance with an example embodiment.

FIGS. 17A-17E illustrate side-views of a rectangular shaped electronic device with different configurations of 3D zones that control the electronic device via a touchless user interface in accordance with an example embodiment.

FIGS. 18A and 18B illustrate a wearable electronic device that provides one or more zones that control the wearable electronic device via a touchless user interface in accordance with an example embodiment.

FIG. 19 illustrates a wearable electronic device that provides a zone that controls the wearable electronic device via a touchless user interface in accordance with an example embodiment.

FIG. 20 illustrates a computer system that includes a plurality of electronic devices and a plurality of servers that communicate with each other over one or more networks in accordance with an example embodiment.

FIG. 21 illustrates an electronic device in accordance with an example embodiment.

FIG. 22 illustrates a wearable electronic device in accordance with an example embodiment.

### SUMMARY OF THE INVENTION

One example embodiment is a method that determines a tap from a finger of a user toward a surface of an electronic device while the surface is face-down and not visible to the user. The electronic device uses a touchless user interface to activate clicks on objects displayed with the electronic device.

### DETAILED DESCRIPTION

Example embodiments include systems, apparatus, and methods that include an electronic device with a touchless user interface.

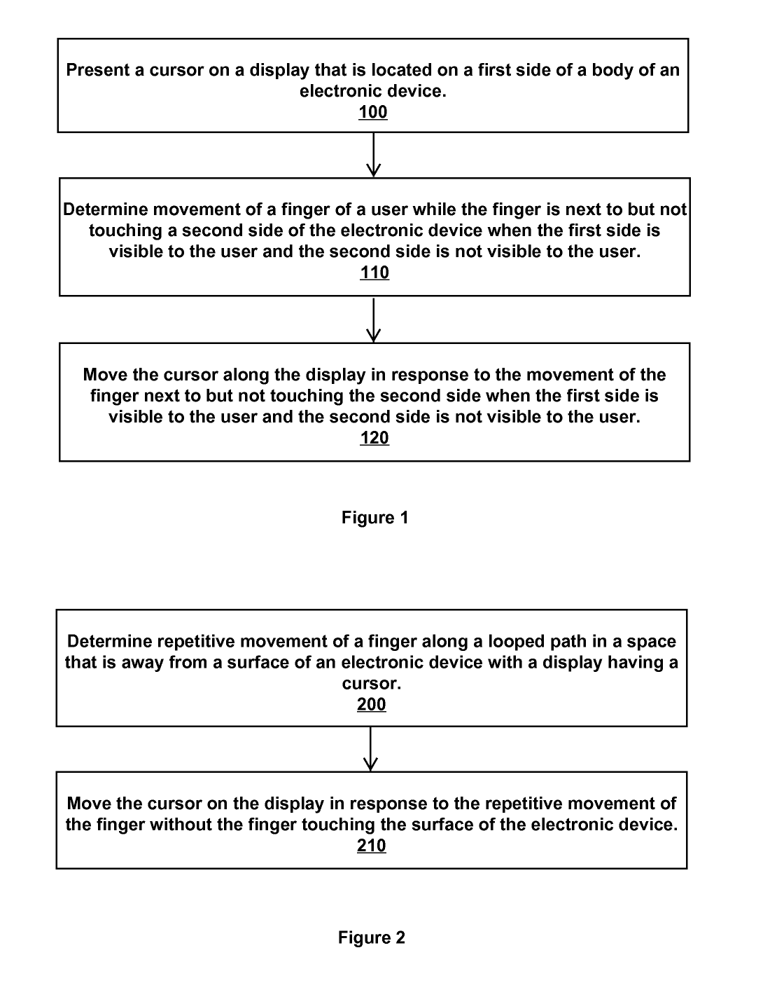

FIG. 1 is a method to move a cursor along a display of an electronic device.

Block 100 states present a cursor on a display that is located on a first side of a body of an electronic device.

For example, the display provides or displays a user interface (UI) or graphical user interface (GUI) with one or more of information, objects, text, background, software applications, hyperlinks, icons, and a cursor. By way of example, the cursor includes, but is not limited to, an arrow, a mouse cursor, a three dimensional (3D) cursor, a pointer, an image, or an indicator that responds to input and/or shows a position on or with respect to the display.

Block 110 states determine movement of a finger of a user while the finger is next to but not touching a second side of the electronic device when the first side is visible to the user and the second side is not visible to the user.

The electronic devices senses, receives, or determines a location and/or movement of the finger while the first side is visible to the user and the second side is not visible to the user. For example, the second side is not within a line-of-sight of the user, is facing away from a view of the user, is obstructed from view of the user, or is otherwise not visible to the user.

Movement of the finger occurs proximate to the second side while the finger does not touch or engage the second side. For example, the electronic device senses, receives, or determines movements of the finger while the user holds the electronic device and while the finger is hidden under the body with the second side being face-down and not visible to the user and with the first side being face-up and visible to the user.

Block 120 states move the cursor along the display in response to the movement of the finger next to but not touching the second side when the first side is visible to the user and the second side is not visible to the user.

A position of the cursor responds to movements of the finger that are touchless with respect to the body of the electronic device. As the finger moves in space near the second side of the body, the cursor simultaneously moves.

Consider an example in which two hands of a user hold a tablet computer with a thin rectangular shape. The tablet computer is held such that a front side with the display faces upward toward the user, and a backside faces away from the user and toward the ground. Fingers of the user are located at the backside and not visible to the user since they are behind or beneath the body of the tablet computer. Two thumbs of the user are located on the front side or on the sides of the tablet computer. Motions of the index fingers of the right and left hands of the user control movement and actions of the cursor that appears on the display located on the front side. These motions occur in an area or space that is located below or next to the backside. These index fingers are not visible to the user since the fingers are behind a body of the tablet computer. Nonetheless, the user is able to control movement and action of a cursor on the display since the cursor moves in response to movements of the index fingers adjacent to the backside.

In this example with the tablet computer, both the left and right index fingers of the user control the cursor. These fingers can simultaneously control the cursor. For instance, consider that the display of the tablet computer has a top and bottom along a Y-axis and a left side and right side along an X-axis in an X-Y coordinate system. As a right index finger of the user moves toward the top in a positive Y direction, the cursor moves toward the top in the positive Y direction. Simultaneously, as a left index finger of the user moves toward the left side in a negative X direction, the cursor moves toward the left side in the negative X direction. Thus, the cursor simultaneously receives movement commands from two different locations and from two different hands of the user while these fingers are located behind or under the tablet computer.

Consider this example with the tablet computer in which one of the index fingers performs repetitive circular movements while the finger is hidden under the body and not visible to the user and is located next to but not touching the backside of the tablet computer that is opposite to the front side when the front side is visible to the user and the backside is not visible to the user. As the finger passes parallel to the backside, the cursor moves along the display. Each loop of the finger thus moves the cursor in a direction that corresponds to the X-Y direction of the finger in its circular movement.

FIG. 2 is a method to move a cursor on a display of an electronic device in response to repetitive movement of a finger.

Block 200 states determine repetitive movement of a finger along a looped path in a space that is away from a surface of an electronic device with a display having a cursor.

The electronic devices senses, receives, or determines a location and/or movement of the finger while the finger is not touching the electronic device. For example, the finger is proximate to one or more surfaces of the electronic device or away from the electronic device (such as being several feet away from the electronic device, several yards away from the electronic device, or farther away from the electronic device).

Block 210 states move the cursor on the display in response to the repetitive movement of the finger without the finger touching the surface of the electronic device.

The finger moves in a repeated fashion along a circular or non-circular path without touching a surface of the electronic device. For example, the path has a closed or open loop configuration that exists in space above, below, adjacent, or away from a surface of the electronic device. The electronic device determines, receives, or senses this movement and path of the finger.

Consider an example in which an HPED monitors movement of a finger as it repeatedly moves in a circle or loop along a path that is adjacent to a surface of the HPED. A cursor of the HPED moves a distance that corresponds to a circumference of the circle multiplied by a number of times that the finger moves along the path. A speed of the cursor also corresponds to a speed of the finger as it moves along the path. As the finger increases its speed, the cursor increases its speed. As the finger decreases its speed, the cursor decreases its speed.

Consider an example in which a single hand (such as the right hand) of a user holds a smartphone with a thin rectangular shape. The smartphone is held such that a first side with a display faces upward toward the user, and a second side (oppositely disposed from the first side) faces away from the user and toward the ground. A right index finger of the user is located at the second side and not visible to the user since it is behind or beneath the body of the smartphone. Motions of the index finger of the user control movement and actions of the cursor that appears on the display. These motions occur in an area or space that is located below or next to the second side. The index finger is not visible to the user since the finger is behind a body of the smartphone. Nonetheless, the user is able to control movement and action of the cursor on the display since the cursor moves in response to movements of the right index finger while the user holds the smartphone with the right hand.

In this example with the smartphone, consider repetitive motion of the right index finger begins at a first point above the second surface, proceeds a distance parallel to the second surface to a second point, moves away from the second surface to third point, and moves toward the second surface to loop back to the first point while the finger is proximate to but not touching the second surface and while the first surface and display are face-up and visible to the user and the second surface is face-down and not visible to the user. This movement of the finger causes the cursor on the display to move a distance that equals the distance between the first point and second point times a number of repetitive motions of the finger along the looped path while the finger is proximate to but not touching the second surface and while the first surface and display are face-up and visible to the user and the second surface is face-down and not visible to the user.

Consider this example with the smartphone in which the display has a top and bottom along a Y-axis, a left side and right side along an X-axis, a Z direction that is perpendicular to the first and second surfaces in an X-Y-Z coordinate system. As the user moves the right index finger in the X direction or the Y direction above the second surface, the cursor simultaneously moves in the corresponding X direction or Y direction on the display. Further, when the user moves the right index finger toward the second surface along the Z-axis, then this movement causes a click action to occur with respect to the cursor on the display. For example, movement of the finger along the Z-axis toward the second surface causes a first click, and movement of the finger along the Z-axis away from the second surface causes a second click or a release of the first click. Thus, movement of the finger along the Z-axis performs an analogous function of clicking with a mouse. For instance, moving the finger toward the second surface is analogous to pressing down on the mouse, and subsequently moving the finger away from the second surface is analogous to releasing of the mouse (such as performing a click and a release of the click).

Consider an example in which a user wears a wearable electronic device, such as portable electronic glasses with a display and a touchless user interface. The glasses track and respond to movements of a right hand and a left hand of the user while the hands are located in predefined areas or zones in front the user (e.g., located at predefined distances and locations from the glasses and/or a body of the user). Movements of the left hand control click or selection operations for objects displayed on the display and movements of the right hand control movements of a cursor or pointer that is movable around the display visible to the user. The glasses sense successive circular motions of a right index finger of the user, and move a cursor across the display in response to these circular motions. The cursor stops on a hyperlink displayed on the display, and the glasses detect a motion of a left index finger toward and then away the glasses. In response to this motion of the left index finger, the glasses execute a click operation on the hyperlink.

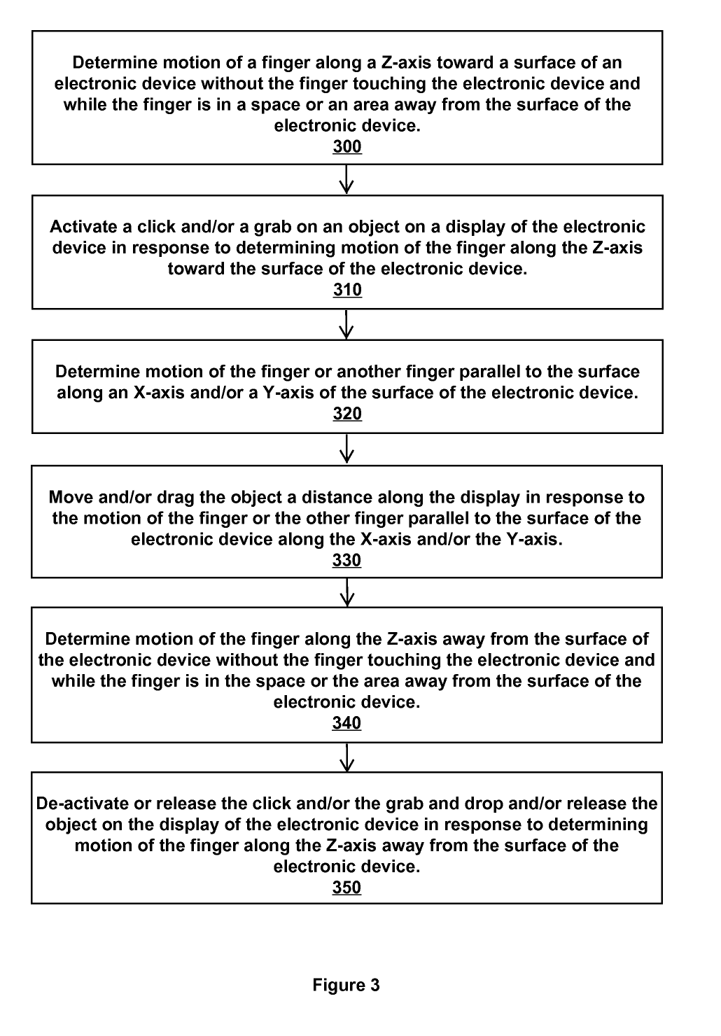

FIG. 3 is a method to perform a click and drag operation of an object on a display of an electronic device in response to motion of a finger along a Z-axis. For illustration, the electronic device is discussed in an X-Y-Z coordinate system in which the X-axis and the Y-axis are parallel to a surface of the electronic device (such as the display), and the Z-axis is perpendicular to this surface with the X-axis and the Y-axis.

Block 300 states determine motion of a finger along a Z-axis toward a surface of an electronic device without the finger touching the electronic device and while the finger is in a space or an area away from the surface of the electronic device.

Movement of the finger occurs proximate to and toward the surface while the finger does not touch or engage the surface. For example, the electronic device senses, receives, or determines movements of the finger while the user holds the electronic device. This finger can be hidden under a body of the electronic device with the surface being face-down and not visible to the user and with the display being face-up and visible to the user. Alternatively, the finger can be visible to the user, such as being over or above the surface and the display that are face-up and visible to the user.

Block 310 states activate a click and/or grab on an object on a display of the electronic device in response to determining motion of the finger along the Z-axis toward the surface of the electronic device.

Motion along the Z-axis selects, activates, highlights, and/or clicks an object on or associated with the display. For example, a pointing device moves to the object, and the motion of the finger along the Z-axis initiates a selection of the object, such as a selection to perform a click, a highlight, or initiate a drag and drop operation.

Block 320 states determine motion of the finger or another finger parallel to the surface along an X-axis and/or a Y-axis of the surface of the electronic device.

Movement of a finger occurs proximate to and parallel with the surface while the finger does not touch or engage the surface. For example, the electronic device senses, receives, or determines movements of this finger while the user holds the electronic device. This finger can be hidden under a body of the electronic device with the surface being face-down and not visible to the user and with the display being face-up and visible to the user. Alternatively, the finger can be visible to the user, such as being over or above the surface and the display that are face-up and visible to the user. Further yet, this finger can be the same finger that moved along the Z-axis or a different finger of the user. For instance, the user moves an index finger of the right hand along the Z-axis to select the object, and then moves one or more fingers and/or thumb of his left hand in a motion parallel to the surface along the X-axis and/or Y-axis to move the selected object.

Block 330 states move and/or drag the object a distance along the display in response to the motion of the finger or the other finger parallel to the surface of the electronic device along the X-axis and/or the Y-axis.

Movement of the object corresponds to movement of the finger in an X-Y plane that is parallel to the surface and/or the display. After the object is selected with movement in the Z-direction, movement in the X-direction and/or the Y-direction causes the object to move about the display. Movement of the object can emulate or correspond to direction and/or speed of the movement of the finger, fingers, thumb, hand, etc.

Movement along the Z-axis activates or selects an object being displayed. Then, movement along the X-axis and/or the Y-axis moves the selected object to different display locations. Thus, once the object is selected with Z-axis motion of the finger, the object can be moved along the display in a variety of different ways. For example, the finger moving in the Z-direction then moves in the X-Y plane to move the selected object. Movement of the finger in the X-Y plane causes movement of the object in the X-Y plane of the display. As another example, after the object is selected with Z-axis motion of the finger, another finger moves in the X-Y plane to move the object. For instance, the finger that moved in the Z-direction remains still or at a current location, and one or more other fingers or a hand moves in the X-Y plane to move the selected object.

Block 340 states determine motion of the finger along the Z-axis away from the surface of the electronic device without the finger touching the electronic device and while the finger is in the space or the area away from the surface of the electronic device.

Movement of the finger occurs proximate to and away from the surface while the finger does not touch or engage the surface. For example, the electronic device senses, receives, or determines movements of the finger while the user holds the electronic device. This finger can be hidden under the body of the electronic device with the surface being face-down and not visible to the user and with the display being face-up and visible to the user. Alternatively, the finger can be visible to the user, such as being over or above the surface and the display that are face-up and visible to the user.

Movement of the finger away from the electronic device per block 340 is opposite to the movement of the finger toward the electronic device per block 300. Movement of the finger per block 300 is toward the electronic device or the display, while movement of the finger per block 340 is away from the electronic device or the display. For example, movement per block 300 is along a negative direction on the Z-axis, and movement per block 340 is along a positive direction on the Z-axis.

Block 350 states de-activate or release the click and/or grab and drop and/or release the object on the display of the electronic device in response to determining motion of the finger along the Z-axis away from the surface of the electronic device.

Motion along the Z-axis unselects, de-activates, un-highlights, and/or releases an object on or associated with the display. For example, the motion along the Z-axis initiates a de-selection of the object, such as completion of the drag and drop operation.

Consider an example in which an index finger moves in a Z-direction toward a surface of a display of an electronic device. This movement activates a click on a virtual object located directly under the moving finger. This finger stops at a location above the display and remains at this location. A thumb located next to the index finger moves to move the selected object. Movements of the object correspond to or coincide with movements of the thumb while the index finger remains fixed or motionless at the location above the display. The index finger then moves in the Z-direction away from the surface of the display, and this movement releases the object and completes the drag and drop operation on the object.

Movement of the finger along the Z-axis in a first direction performs a click action, and movement of the finger along the Z-axis in a second direction (opposite to the first direction) performs a second click action or a release of the click action.

Consider an example in which a cursor on a display of an HPED tracks movement of a finger while the finger moves in an area adjacent a surface that is not visible to a user holding the HPED. Movement of the finger along a Z-axis toward the HPED activates a click or tap, and movement of the finger along the Z-axis away from the HPED releases the click or the tap. For instance, movement along the Z-axis toward and then away from the HPED would be analogous to a user clicking a mouse button and then releasing the mouse button or a user tapping a display of a touch screen with a finger and then releasing the finger from the touch screen.

Consider an example in which a smartphone has a thin rectangular shape with a display on a first side. The smartphone determines a position of a hand or finger of a user at two different zones that are located in X-Y planes located above the display. A first zone is located from about one inch to about two inches above the display, and a second zone is located from the surface of the display to about one inch above the display. Movement of the finger through or across the first and second zones causes a pointing device to move in the display. For instance, a user controls a cursor or pointer by moving a finger in X and Y directions through the first and second zones. Movement of the finger from the first zone to the second zone along a Z-axis, however, causes or activates a click operation or selection on the display. Movement of this finger from the second zone back to the first zone deactivates or releases the click operation.

Continuing this example of the smartphone, the user moves his index finger through the first and/or second zone along X and Y directions to move a pointing device on the display. The pointing device stops on a hyperlink. The user then moves the index finger toward the display along the Z-axis and then away from the display along the Z-axis, and this action of moving toward and away from the display causes a click on the hyperlink that navigates to a corresponding website.

Continuing this example of the smartphone, the user moves his thumb in an X and Y directions through the first and/or second zone to move a pointing device in X and Y directions along the display. The pointing device stops on a folder shown on the display. The user then moves the thumb toward the display along the Z-axis from a location in the first zone to a location in the second zone, and this action of moving from the first zone to the second zone and towards the display along the Z-axis causes a click or selection on the folder. While the folder is selected and with the thumb remaining in the second zone, the user moves his index finger in an X-direction and/or a Y-direction in the first or second zone. This movement of the index finger causes the folder to move in a corresponding direction on the display. When the folder moves to the desired location, the user moves the thumb along the Z-axis from the location in the second zone back to the first zone. This action of moving from the second zone back to the first zone and away from the display along the Z-axis causes a de-selection or release of the folder.

Movements of the finger along the Z-axis and through the first and second zones causes click actions to occur with the pointer or at locations corresponding to the moving finger. As one example, movement of a finger from the first zone to the second zone causes a first click, and movement of the finger from the second zone back to the first zone causes a second click. As another example, movement of a finger from the first zone to the second zone causes a first click, and movement of the finger from the second zone back to the first zone causes a release of the first click. As another example, movement of a finger from the second zone to the first zone causes a first click, and movement of the finger from the first zone back to the second zone causes a second click. As yet another example, movement of a finger from the second zone to the first zone causes a first click, and movement of the finger from the first zone back to the second zone causes a release of the first click.

Consider an example in which an electronic device includes two different areas or zones that a user interacts with via a touchless user interface. Both a first zone and a second zone extend outwardly from a display of the electronic device such that the two zones are adjacent to each other but not overlapping. The first zone is dedicated to one set of functions, and the second zone is dedicated to another set of functions. For example, the first zone detects motions of a hand and/or finger to perform click or selection operations, and the second zone detects motions of a hand and/or finger to perform movements of a cursor or navigation around the display. For example, a user moves a right index finger above the display in the second zone to move a cursor around the display and moves a left index finger above the display in the first zone to execute click operations with the cursor. For instance, movements of the right index finger along an X-Y plane in the first zone correspondingly move the cursor in an X-Y plane on the display. Movements of the left index finger along a Z-plane effect clicks of the cursor on the display. Simultaneous movements of the right and left index fingers above the display move the cursor and effect click operations.

Consider an example in which an electronic device includes two different areas or zones that a user interacts with via a touchless user interface. A first zone extends outwardly from and above a first side of the electronic device with a display, and a second zone extends outwardly from and below a second side that is oppositely disposed from the first side. The second zone detects motions of a hand and/or finger to perform click or selection operations, and the first zone detects motions of a hand and/or finger to perform movements of a cursor or navigation around the display. For example, a user moves a right index finger above the display in the first zone to move a cursor around the display and moves a left index finger below the display in the second zone to execute click operations with the cursor. For instance, movements of the right index finger along an X-Y plane in the first zone correspondingly move the cursor in an X-Y plane on the display. Movements of the left index finger along an X-Y plane effect clicks of the cursor on the display. Simultaneous movements of the right and left index fingers above and below the display move the cursor and effect click operations.

Consider an example in which a user wears a wearable electronic device, such as portable electronic glasses with a display and a touchless user interface. X-Y axes extend parallel to the lens of the glasses, and a Z-axis extends perpendicular to the lens of the glasses. The display presents the user with a cursor that navigates around the display to different objects, such as icons, links, software applications, folders, and menu selections. A first motion of a right index finger along the Z-axis (which is toward the glasses and a head of the user) activates a click or grab operation on an object selected by the cursor. Motion of the right thumb along the X-Y axes (which are parallel to the lens of the glasses and to a body of the user) then moves or drags the selected object from a first location on the display to a second location on the display. A second motion of the right index finger along the Z-axis deactivates the click or grab operation on the object and leaves the object positioned on the display at the second location.

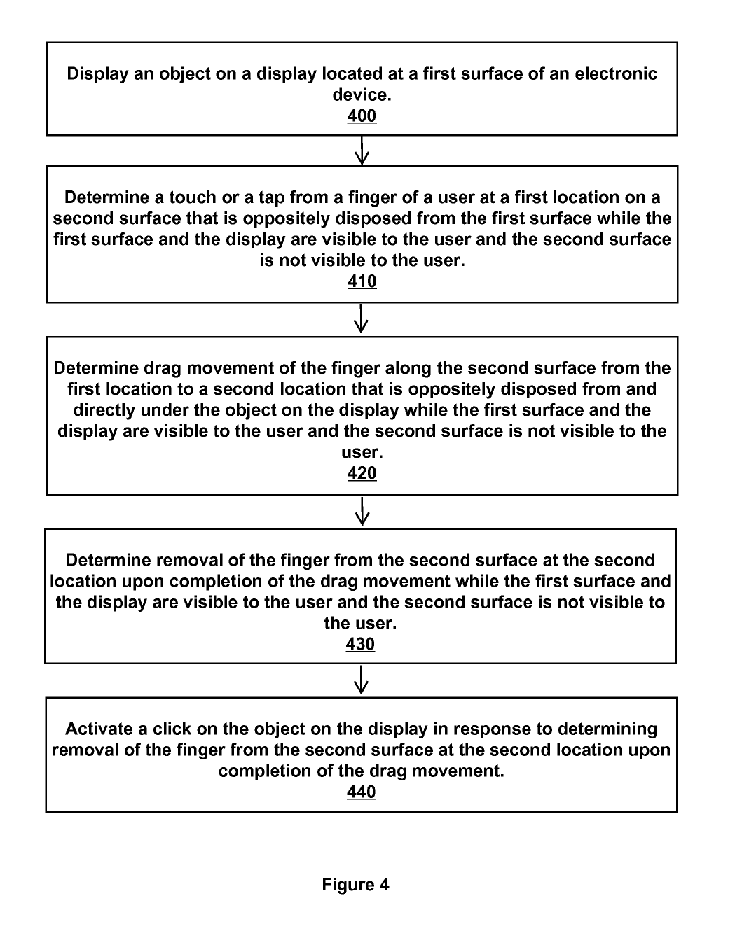

FIG. 4 is a method to activate a click on a display of an electronic device from a surface that is not visible to a user.

Block 400 states display an object on a display located at a first surface of an electronic device.

For example, the display provides or displays a UI or GUI with one or more of information, objects, text, background, software applications, hyperlinks, icons, and a cursor, such as an arrow, a mouse cursor, a three dimensional (3D) cursor, a pointer, or an indicator that responds to input and/or shows a position on or with respect to the display.

Block 410 states determine a touch or a tap from a finger of a user at a first location on a second surface that is oppositely disposed from the first surface while the first surface and display are visible to the user and the second surface is not visible to the user.

The electronic devices senses, receives, or determines movement of a finger and/or a tap or touch from the finger at the second surface while this second surface is face-down and/or not visible to the user. For example, the electronic device could be a tablet computer with a thin rectangular shape having a display on a flat front side and an oppositely disposed flat back side. A user holds the tablet computer while standing such that the display faces upwardly toward the user and the back side faces downwardly away from the user and to the ground. In this position, the display is face-up, and the back side is face-down. The user taps or touches this back side with a finger, hand, thumb, or object.

Block 420 states determine drag movement of the finger along the second surface from the first location to a second location that is oppositely disposed from and directly under the object on the display while the first surface and the display are visible to the user and the second surface is not visible to the user.

The electronic devices senses, receives, or determines movement of the finger across or along the display starting at a first location where the tap or touch occurred to a second location.

Block 430 states determine removal of the finger from the second surface at the second location upon completion of the drag movement while the first surface and the display are visible to the user and the second surface is not visible to the user.

The electronic devices senses, receives, or determines removal of the finger at the second location upon completion of the finger moving across the display from the first location to the second location.

Block 440 states activate a click on the object on the display in response to determining removal of the finger from the second surface at the second location upon completion of the drag movement.

Removal of the finger at the second location activates or causes a click or selection operation to occur on an object or at a location that corresponds to a position of the finger on the second surface.

An object on a display can be highlighted to visually signify a selection of this object and/or a location of a cursor or pointing device. As one example, an object on a display located on a first side is highlighting when a finger is oppositely disposed from and directly under a location of the object while the finger is proximate but not touching a second surface (oppositely disposed from the first surface) and while the first surface and display are face-up and visible to the user and the second surface is face-down and not visible to the user. In this example, the finger can be touching the second side or located above the second side, such as being in a space below the second side. For instance, the finger is not visible to the user while located at the second side since a body of the electronic device is between the finger and a line-of-sight of the user holding and/or using the electronic device. As another example, an object on a display located on a first side is highlighted when a finger is oppositely disposed from and directly over a location of the object while the finger is proximate but not touching a first surface on which the display is located and while the first surface and display are face-up and visible to the user and the second surface is face-down and not visible to the user. In this example, the object becomes highlighted when the finger moves to a location in space that is over where the object appears on the display on the first side.

Objects can be highlighted, marked, or distinguished in other instances as well. For example, a finger initiates a drag movement across the second side from a first location to a second location while the second side is not visible to the user yet the first side is visible to the user. An object on the display of the first side is highlighted after the finger completes the drag movement from the first location to the second location such that the finger is oppositely disposed from and directly under the object. Alternatively, drag movement of the finger causes a cursor or pointing device to move to the object, and the object becomes highlighted in response to movement of the cursor or pointing device at the object.

Further yet, the display can highlight a path of movement of the finger when the finger interacts with the display regardless of whether the finger moves on the display, above or below the display, on the first side or second side, or above or below the first side or the second side. By way of example, the drag movement on the display is a line on the display that represents dragging or moving of the finger from a first location to a second location.

Consider an example in which a two-sided tablet computer has a first display on a first side and a second display on a second side that is oppositely disposed from the first side. When the first side is face-up and visible to a user and the second side is face-down and not visible to the user, the first display activates and the second display becomes a touch pad with a UI to interact with the first display. In this orientation, the first side is the display, and the second side is the touch pad. With the first side face-up and the second side face-down, a user moves his finger along a surface of the second side and/or through an area in space adjacent to the second side in order to control a cursor or pointing device that appears on the display on the first side. The pointing device simultaneously moves with and tracks movement of the finger as it moves with respect to the second side. A virtual keyboard appears on the first display on the first side, and the user moves his fingers with respect to the second side to type onto this keyboard.

Flipping of the tablet causes the second side to become the display and the first side to become the touch pad. When the second side is face-up and visible to the user and the first side is face-down and not visible to the user, the second display activates and the first display becomes a touch pad with a UI to interact with the second display. In this orientation, the second side is the display, and the first side is the touch pad. With the second side face-up and the first side face-down, a user moves his finger along a surface of the first side and/or through an area in space adjacent to the first side in order to control a cursor or pointing device that appears on the display on the second side. The pointing device simultaneously moves with and tracks movement of the finger as it moves with respect to the first side. A virtual keyboard appears on the second display on the second side, and the user moves his fingers with respect to the first side to type onto this keyboard.

Continuing with this example of the tablet computer with the virtual keyboard on the first display with the first side face-up and the second side face-down, the user can type or activate the keys in different ways by interacting with the first side and/or second side. Consider an example in which the user desires to type or activate the letter J on this keyboard. As a first example, the user positions his finger in a space directly above the letter J on the first display and/or positions a cursor or pointing device on the letter J and moves or motions his finger toward the first side and/or the letter J and then moves or motions his finger away from the first side and/or the letter J without actually touching the letter J or the first side. This motion of moving the finger toward and away from first side and/or the location of the letter activates, clicks, or types the letter J. As a second example, the user moves or motions his finger toward another location on the first display, such as the letter G. The user then moves his finger in space until it is over the letter J and/or until the cursor or pointing device is at the letter J and moves his finger away from the first side. The first motion of moving the finger toward the keyboard signified a desire to perform a type on a letter. The second motion of moving the finger away from the keyboard above the letter J or with the cursor or pointing device at the letter J signified a desire to type the letter J. As a third example, the user taps the first display at the letter J on the virtual keyboard to type this letter. As a fourth example, the user taps a designated area on the first side while the cursor or pointer is located at the letter J. This designated area, for instance, is on the virtual keyboard but adjacent to the letters of the keyboard. As a fifth example, the user touches the keyboard at another location (i.e., where the letter J is not located) on the first display, such as the letter G. The user then moves or drags his finger on the first display until it is on the letter J and removes his finger. A location of where the finger is removed from the display activates a click or typing indication at this location. As a sixth example, the user touches a location on the first display next to the keyboard (e.g., where no letters are located) on the first display. The user then moves or drags his finger in this designated area on the first side until the cursor or pointing device is on the letter J and removes his finger. Removal of the finger from the first side while the cursor or pointing device is at the letter J activates a click or typing indication at the letter J.

Continuing with this example of the tablet computer with the virtual keyboard on the first display with the first side face-up and the second side face-down, the user can type or activate the keys in different ways by interacting with the second side or second display. Consider an example in which the user desires to type or activate the letter J on this keyboard. As a first example, the user moves his finger in a space or area adjacent to the second side until his finger is in a space directly below the letter J on the first display and/or positions a cursor or pointing device on the letter J. The cursor or pointing device on the first display tracks movement of the finger with respect to the second side so the user is aware of its location with respect to the first display. With the cursor or pointing device on the letter J and/or the finger directly under the letter J on the second side, the user moves or motions his finger toward second side and/or the letter J and then moves or motions his finger away from the second side and/or the letter J without actually touching the second side. This motion of moving the finger toward and away from the location of the second side and/or location of the letter J activates, clicks, or types the letter J. As a second example, the user moves or motions his finger toward another location on the second display, such as the letter G. The user then moves his finger in space below the second side until it is below a location of the letter J appearing on the first display and/or until the cursor or pointing device is at the letter J. The user then moves his finger away from the second side. The first motion of moving the finger toward the second side signified a desire to perform a type on a letter. The second motion of moving the finger away from the second side under the letter J or with the cursor or pointing device at the letter J signified a desire to type the letter J. As a third example, the user taps the second side at a location that is directly under the letter J on the virtual keyboard on the first display to type this letter. As a fourth example, the user taps a designated area on the second side while the cursor or pointer is located at the letter J. This designated area, for instance, is on the second side in an area below the virtual keyboard but adjacent to the letters of the keyboard. As a fifth example, the user touches the second side at another location (i.e., where the letter J is not located) on the first display, such as the letter G. The user then moves or drags his finger on the second side until it is directly under the letter J and removes his finger. A location of where the finger is removed from the second side under the letter J activates a click or typing indication at this location. As a sixth example, the user touches a location on the second display that corresponds to a location next to the keyboard (e.g., where no letters are located) on the first display. The user then moves or drags his finger in this designated area on the second side until the cursor or pointing device is on the letter J and removes his finger. Removal of the finger from the second side while the cursor or pointing device is at the letter J on the first side activates a click or typing indication at the letter J.

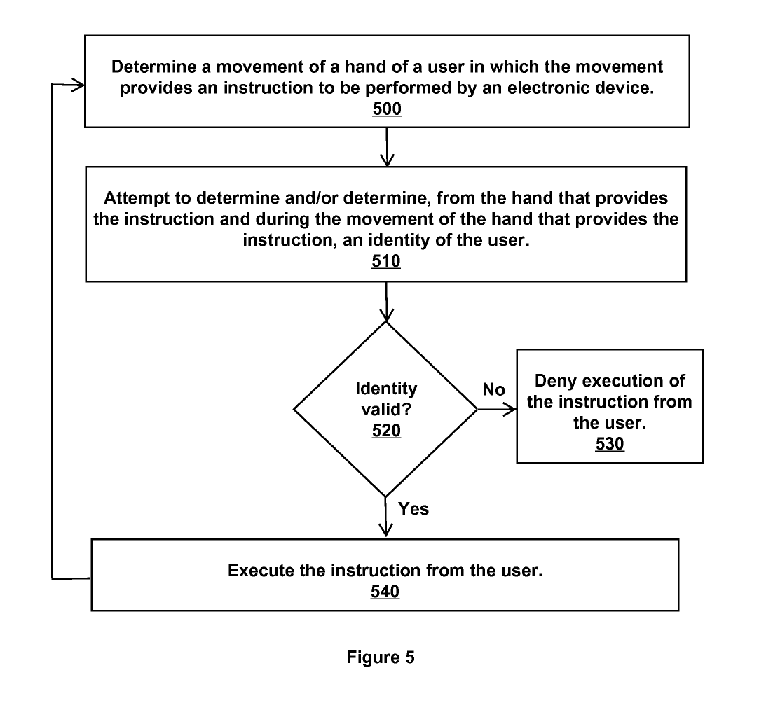

FIG. 5 is a method to execute an instruction upon determining an identity of a user of an electronic device.

Block 500 states determine a movement of a hand of a user in which the movement provides an instruction to be performed by an electronic device.

For example, the electronic device senses, receives, or determines movements of the hand while the user holds the electronic device and/or interacts with the electronic device. Further, movement of the hand occurs on, proximate to, or away from a surface or a side of the electronic device. For example, the hand touches a front-side or back-side of the electronic device in order to provide the instruction. As another example, the hand performs the movement in a space or area not on the electronic device, such as a touchless command or instruction in an area next to a surface of the electronic device.

The hand can be hidden under the body of the electronic device and not visible to the user holding and/or interacting with the electronic device. For example, the electronic device can have a front-side with a display and a back-side that is oppositely disposed from the front-side. A sensor senses the hand with respect to the back-side while the back-side is face-down and not visible to the user and the display and front-side are face-up and visible to the user. Alternatively, the hand can be visible to the user, such as being over or above the front-side and the display that are face-up and visible to the user.

The user can communicate with the electronic device with touchless interactions, such as a touchless gesture-based user interface. A touchless user interface enables a user to command an electronic device with body motion and gestures while not physically touching the electronic device, a keyboard, a mouse, and/or a screen.

Block 510 states attempt to determine and/or determine, from the hand that provides the instruction and during the movement of the hand that provides the instruction, an identity of the user.

The electronic device obtains information from a body of the user and/or gestures or movements of the user in order to determine or attempt to determine an identity of the user. For example, biometrics or biometric authentication attempts to identify or does identify the user according to his or her traits or characteristics. Examples of such biometrics include, but are not limited to, fingerprint, facial recognition, deoxyribonucleic acid (DNA), palm print, hand geometry, iris recognition, and voice recognition.

Block 520 makes a determination as to whether the identity of the user is valid and/or the user is authenticated to perform the instruction. If the answer to this determination is “no” then flow proceeds to block 530. If the answer to this determination is “yes” then flow proceeds to block 540.

Block 530 states deny execution of the instruction from the user. Flow then proceeds back to block 500.

When an identity of the user is not valid or authenticated, then the instruction received from the user is not executed.

Block 540 states execute the instruction from the user. Flow then proceeds back to block 500.

When an identity of the user is valid or authenticated, then the instruction received from the user is executed.

The electronic device makes an attempt to determine the identity of the user from the movement of a hand, one or more fingers, an arm, a body part of the user, a gesture, etc. By way of example, consider three different outcomes from this determination. First, the electronic device determines an identity of the user from a hand movement, authenticates or confirms the user as having authority to perform the requested instruction, and executes the requested instruction. Second, the electronic device determines an identity of the user from a hand movement, is unable to authenticate or confirm the user as having authority to perform the requested instruction, and denies execution of the requested instruction. Third, the electronic device is not able to determine an identity of the user from a hand movement and denies execution of the instruction. For instance, a fingerprint of the user is accurately and correctly read, but the electronic device has no record of this user. As another instance, an error occurs during the reading of the identity of the user. As yet another instance, the electronic device correctly identifies the user, but this user does not have authority to execute the requested instruction.

Consider an example in which a user holds a tablet computer with a left hand such that a first side of the tablet computer with a display faces the user and a second side faces away toward the ground and away from the user. The second side is not visible to the user. While holding the tablet computer in this orientation, a right hand of the user moves next to and/or on the second side in order to control a cursor on the display and in order to provide instructions to the tablet computer. Each time the right hand moves to control the cursor and/or provides an instruction, the tablet computer identifies the user and authenticates that the user has authority to execute the requested instruction. For instance, the user moves an index finger of the right hand in order to move the cursor and to perform click operations with the cursor on the display. Each and every time the index finger moves with respect to the second side to provide an instruction, the tablet computer identifies the user (e.g., reads a fingerprint of the index finger) and authenticates the user to perform the instruction. These actions occur while the index finger is hidden under the body of the tablet computer and not visible to the user and located next to but not touching the second side when the first side is visible to the user and the second side is not visible to the user. Further, these actions occur while the finger is moving to provide the instruction. Authentication of the user simultaneously occurs during movement of the finger to provide the instructions.

Authentication of the user can occur before each instruction or at a beginning of each instruction of the user. For example, a user desires to move a cursor across the display and provides a straight-line movement of his index finger above the display to cause this cursor movement. As the finger of the user moves into position above the display before the straight-line movement, the electronic device reads a fingerprint of the user. Authentication of the user occurs immediately before the finger begins to move in the straight-line movement. As another example, the electronic device authenticates an identity of a hand of a user while the hand is in a zone or area adjacent to a side of the electronic device. While the hand remains in this zone, the user is authenticated, and movements of the hand perform operations to instruct the electronic device. When the hand moves out of this zone, authentication ceases. Thereafter, when the hand moves back into this zone, the user is authenticated.

Consider an example in which a user holds a smartphone in his right hand while an index finger of his right hand moves adjacent to a backside of the smartphone that is not visible to the user. While the index finger is hidden from view of user, this finger instructs the smartphone via a touchless gesture-based user interface. Each time the finger performs a command and/or instruction, the smartphone identifies and/or confirms an identity of the user. For instance, the smartphone executes continuous or periodic facial recognition of the user while the user holds the smartphone. The user then hands the smartphone to a third person that is not an owner of the smartphone. This third person holds the smartphone in her right hand while an index finger of her right hand moves adjacent to the backside of the smartphone that is not visible to her. The smartphone reads movements of her index finger as an instruction to open a folder on the display. The smartphone, however, denies execution of this instruction since she is not an owner of the smartphone and hence does not have authorization to open the folder.

Consider an example in which a user wears a wearable electronic device that includes a touchless user interface. This wearable electronic device executes hand and/or finger motion instructions from the user when it identifies and authenticates a finger or hand of the user providing motions within a tracking zone or area. While the user communicates with the wearable electronic device via the touchless user interface, a hand of another user comes within the tracking zone and emulates a motion that is an instruction. The wearable electronic device reads and/or senses this hand and motion of the other user but does not execute the instruction since this other user is not authorized to interact with the wearable electronic device. The wearable electronic device ignores the instruction from the other user and continues to receive and execute instructions from the user even though a hand of the other user is also in the tracking zone with the hand of the user. Thus, the wearable electronic device distinguishes between hands and/or fingers in the tracking zone that are authorized to instruct the wearable electronic device and hands and/or fingers in the tracking zone that are not authorized to instruct the wearable electronic device.

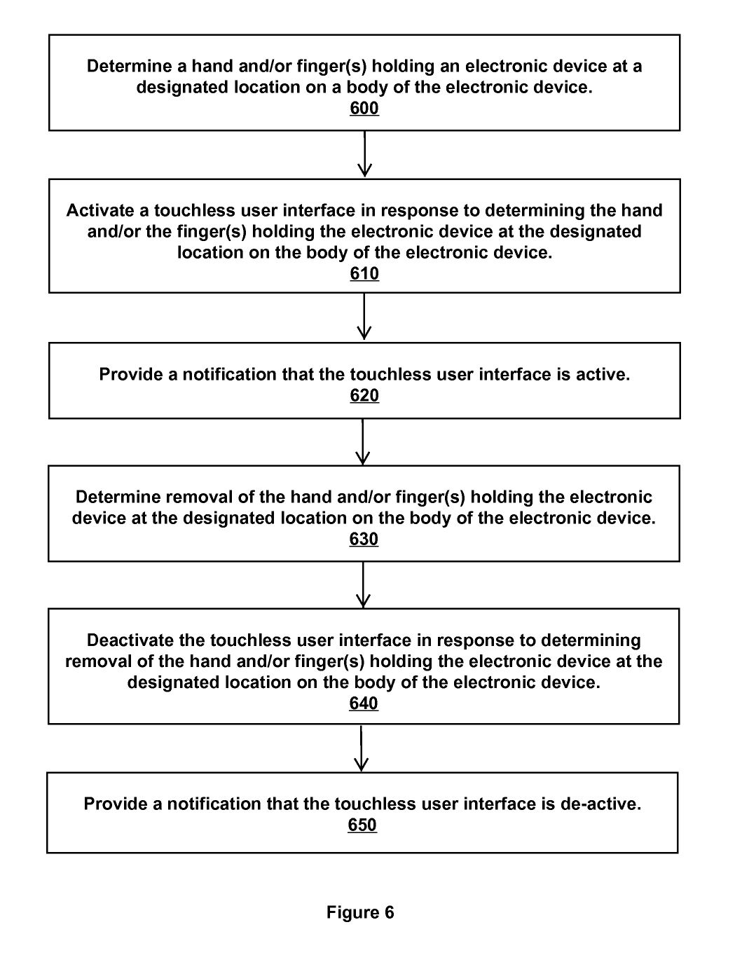

FIG. 6 is a method to activate and de-activate a touchless user interface of an electronic device.

Block 600 states determine a hand and/or finger(s) holding an electronic device at a designated location on a body of the electronic device.

The electronic devices senses, receives, or determines positions and/or locations of a hand and/or finger(s) holding the electronic device.

Block 610 states activate a touchless user interface in response to determining the hand and/or finger(s) holding the electronic device at the designated location on the body of the electronic device.

The electronic device includes one or more areas that when held or touched activate the touchless user interface. For example, when a user holds or grasps the electronic device with a certain hand or with one or more fingers located at a specific location, then this action activates or commences the touchless user interface. For instance, the touchless user interface is activated and remains activated while the user holds the electronic device in his left hand with his thumb and another finger gripping a perimeter of the electronic. As another instance, the touchless user interface activates when a user positions his thumb along a perimeter or side surface of the electronic device at a designated location.

Block 620 states provide a notification that the touchless user interface is active.

The electronic device provides a notice that the touchless user interface is activated and/or remains active. A user can perceive this notice and determine that the touchless user interface is active.

Block 630 states determine removal of the hand and/or finger(s) holding the electronic device at the designated location on the body of the electronic device.

The electronic devices senses, receives, or determines that the hand and/or fingers(s) at the positions and/or locations holding the electronic device are removed or moved.

Block 640 states deactivate the touchless user interface in response to determining removal of the hand and/or finger(s) holding the electronic device at the designated location on the body of the electronic device.

When the user releases the hold or grasp of the electronic device with the certain hand or finger(s) located at the specific location, then this action deactivates or stops the touchless user interface. For instance, the touchless user interface actives while the user holds the electronic device at a designated location and/or in a certain manner, and deactivates or ceases when the user stops holding the electronic device at the designated location and/or in the certain manner. As another example, the touchless user interface activates when the user touches the designated location and remains active until the user again touches the designated location or another designated location.

Block 650 states provide a notification that the touchless user interface is de-active.

The electronic device provides a notification when the user activates the touchless user interface and a notification when the user deactivates the touchless user interface. A notification can appear upon activation of the touchless user interface and remain present while the touchless user interface is active. A notification can also appear upon deactivation of the touchless user interface. Examples of a notification include, but are not limited to, an audible sound (e.g., a distinctive short sound that signifies activation of the touchless user interface) and a visual indication (e.g., indicia on the display that signifies activation and/or an active state of the touchless user interface).

Consider an example in which a message appears on a display of the electronic device to notify a user that the touchless user interface is active. A small visual indication (such as a light or illumination) stays on the display and/or is visible to the user while the touchless user interface remains active. This indication enables the user to know when the touchless user interface is active and when it is not active. When the touchless user interface deactivates or ceases, the visual indication disappears. Disappearance of or absence of the visual indication indicates that the touchless user interface is no longer active.

Consider an example in which a user holds his smartphone in his left hand with his thumb along one side of a perimeter of the body and one or more fingers along an opposite side of the body. Upon sensing the position of the thumb and fingers at these locations, the smartphone enters into a touchless user interface mode in which the user interfaces with the smartphone with hand and/or finger movements relative to a front side and a back side of the smartphone. For instance, movements of the right index finger of the user above the front display and/or back display control movements of a cursor on the display. The user moves this finger toward the display and this movement activates a click of the cursor on the display. The user then changes his grip of holding the smartphone such that the backside rests in his right fingers with his right thumb on the front display. Upon sensing removal of the left thumb and fingers at the designated locations, the smartphone ceases the touchless user interface and switches to a touch interface mode wherein the user taps on the display to interface with the smartphone.

Consider an example in which a user positions his thumb at a specific location on the display of an HPED in order to authenticate himself and activate a touchless user interface mode. This mode remains active while the user continues to hold the HPED in various different positions in his hands. The user then places the HPED on a table, and the HPED senses that the user is no longer holding the HPED and deactivates the touchless user interface mode.

Consider an example in which a user interacts with an HPED to establish a hand position that activates a touchless user interface mode. The HPED instructs the user to hold and/or grab the HPED at any location or position desired by the user. The HPED then senses the hand and/or finger positions at these locations, saves these sensed positions, and associates these positions with future activation of the touchless user interface mode. Thereafter, when the user places his hand and/or fingers at these positions, the HPED activates the touchless user interface mode. As such, a user interacts with the HPED to set and establish specific locations on the HPED that when grabbed or touched activate the touchless user interface mode.

Consider an example in which a user desires to personalize his smartphone to active a touchless user interface mode when the user holds the smartphone at specific locations that the user designates to the smartphone. The smartphone instructs the user to hold the smartphone at locations determined by or decided by the user. In response to this request, the user holds the smartphone in his left hand such that the smartphone is gripped between his left index finger along a top perimeter side and his left thumb along a bottom perimeter side that is oppositely disposed from the top side. As such, the user holds the smartphone between his index finger on one side and his thumb on an oppositely disposed side. While holding the smartphone in this position, the smartphone senses positions of the left index finger and the thumb and associates these positions with activation of the touchless user interface mode. Thereafter, when the user grabs or holds the smartphone with the finger and thumb in these positions, activation of the touchless user interface mode occurs. As such, the user is able to configure his smartphone to activate touchless user interface upon determining a specific personalized hold or grasp that the user designates to the smartphone.

Consider an example in which a user wears a wearable electronic device, such as portable electronic glasses that include lenses and a display with a touchless user interface. The glasses activate and deactivate the touchless user interface when they detect two consecutive taps or touches on its body or frame from two fingers and a thumb of the user. For instance, the glasses transition to and from the touchless user interface when the user consecutively taps or grabs twice the frame or foldable legs with the right index finger, the right middle finger, and the right thumb. When these two fingers and thumb simultaneously touch or tap the frame or foldable legs twice, the glasses activate the touchless user interface when this interface is not active and deactivate the touchless user interface when this interface is active.

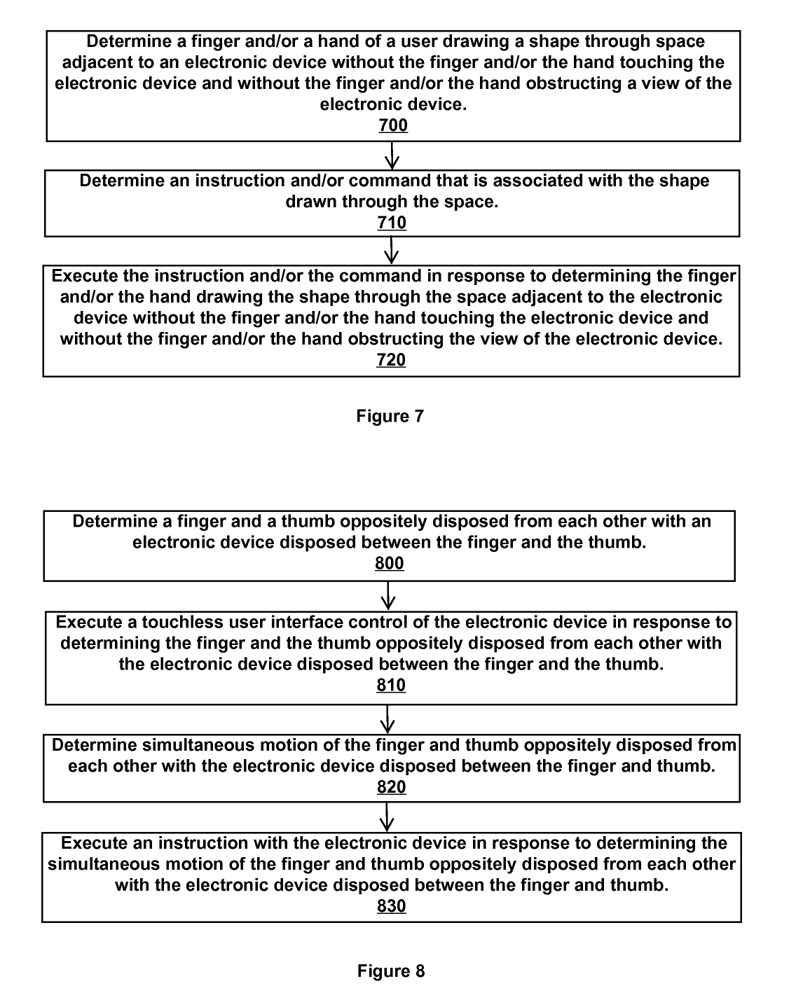

FIG. 7 is a method to execute an instruction based on determining a drawn shape through space adjacent an electronic device.

Block 700 states determine a finger and/or a hand of a user drawing a shape through space adjacent to an electronic device without the finger and/or the hand touching electronic device and without the finger and/or hand obstructing a view of the electronic device.

The electronic devices senses, receives, or determines movements of the finger and/or hand through the space. For example, the electronic device tracks a location and/or movement of a finger of a user and determines the finger follows a predetermined two-dimensional (2D) or three-dimensional (3D) path in an area located next to a side of an electronic device. The finger traverses this path without touching or contacting the electronic device.

Block 710 states determine an instruction and/or command that is associated with the shape drawn through the space.

Different 2D or 3D shapes are associated with different instructions, commands, and/or software applications. For example, the electronic device and/or another electronic device in communication with the electronic device stores a library of different paths or shapes and an instruction, command, and/or software application associated with each of these different paths or shapes. For instance, a path of the number “8” drawn in space above a side of the electronic device is associated with opening a music player; a path of an elongated oval drawn in the space is associated with opening a browser; and a path of an “X” drawn in the space is associated with closing an application, a window, or a folder.

Block 720 states execute the instruction and/or the command in response to determining the finger and/or the hand drawing the shape through the space adjacent to the electronic device without the finger and/or the hand touching electronic device and without the finger and/or hand obstructing the view of the electronic device.

The electronic device determines a shape or path, retrieves an instruction and/or command associated with the shape or path, and executes the retrieved instruction and/or command. With this touchless user interface, a user can issue instructions and/or commands without seeing his or her hand or other body part issuing the instruction and/or command. For instance, a hand of the user is remote or hidden or not visible beneath or under a body of the electronic device while the user holds or interacts with the electronic device. In this manner, the hand of the user issuing the instruction and/or command does not obstruct a view of the electronic device (e.g., the hand does not obstruct a view of the display since the hand is located out of a line-of-sight from the user to the display.

Consider an example in which a user holds a smartphone in his left hand and interacts with the smartphone through a touchless user interface using his right hand. The right hand of the user is located behind or under the smartphone such that the right hand does not obstruct a display of the smartphone that is visible to the user. Finger and hand movements from the right hand provide instructions to the smartphone through the user interface while the right hand is located behind or under the smartphone. For instance, the smartphone tracks, senses, and interprets movements of the fingers and thumb of the right hand while they move through an area adjacent to a side of the smartphone facing away from or not visible to the user. In this position, the right hand of the user is not in a line-of-sight from the user to the smartphone. Tracking of the right hand continues as the user moves his hand from behind the smartphone to locations next to and above the smartphone. In these positions, the right hand of the user is visible (since it is no longer under the smartphone) but not obstructing a view of the display. Hand and/or finger movements at this location continue to control operation of the smartphone. As such, the smartphone can track locations and movements of the right hand from various different locations with respect to the smartphone and receive and execute instructions from these locations.

Consider an example in which a user controls a thin rectangular shaped tablet computer through a touchless user interface while the tablet computer rests on a flat surface of a table located in front of the user. The tablet computer tracks a location and/or movements of the right hand and/or right fingers of the user as the user interacts with the tablet computer. A dome-shaped or hemi-spherically shaped tracking area extends above the tablet computer from the table. When the right hand of the user is within this area, the tablet computer receives and interprets gestures of the right hand. For instance, the user can issue instructions to the tablet computer while the right hand is located anywhere within the dome-shaped tracking area, such as being above, next to, in front of, to the side of, and near the tablet computer.

Consider an example in which a HPED has a variable tracking area that extends in 3D space around the HPED. When a user is located in this area, the user can control the HPED with body movements. For example, while being physically several feet away from the HPED, the user performs multiple hand and finger gestures to send a text message from the HPED.

A series of two or more shapes can be added together to provide multiple instructions and/or commands. For example, an electronic device can sense a plurality of different shapes that are consecutively or successively drawn in space to provide a series of instructions to the electronic device. For instance, an electronic device senses a finger that draws the following shapes in rapid succession in 3D space near the electronic device: a circle parallel to a display surface of the electronic device, an oval perpendicular to the display surface, and three tap movements directed perpendicular and toward the display surface. The circular movement instructs the electronic device to save a text document open in an active window on the display; the oval movement instructs the electronic device to close the text document and its executing software application; and the three tap movements instruct the electronic device to go into sleep mode.

Multiple shapes can be drawn and/or sensed in rapid succession to provide a series of continuous instructions. For example, each shape is drawn and/or sensed in about one second or less. For instance, a user draws a series of five different shapes with each shape being drawn in about one second. Each shape represents a different instruction and/or command that the electronic device executes.

Consider an example in which a smartphone executes a touchless user interface that communicates with a cloud server over the Internet. The user desires to open a media player application that is hosted by the cloud server. In order to open this application, the user draws (while holding the smartphone in his hand) a circle “O” and then the letter “L” in the air or space beneath the smartphone. The circle indicates that the user desires to open an application, and the letter indicates that the user desires to open the media player application. The smartphone detects the first command (i.e., the circular movement of the finger), and this first command instructs the smartphone that the user wants to open a software application. The smartphone then detects the second command (i.e., the “L” movement of the finger), and this second command instructs the smartphone to communicate with the cloud server and retrieve and open the media player application to the display of the smartphone.

The electronic device can execute instructions and/or commands based on simultaneously or concurrently determining, receiving, and/or sensing multiple different movements of one or more fingers and/or hands. For example, the user can simultaneously issue instructions with both the left hand and the right hand while these hands are not touching the electronic device.

The electronic device can interact with a user such that the user can draw custom shapes and/or designs and then select instructions and/or commands to associate with these customized shapes and/or designs. For example, the electronic device enters a customization instruction mode and requests the user to draw a 2D or 3D shape. The electronic device senses the user drawing a 2D circle parallel to and adjacent with the display. The electronic device then requests the user to select an instruction to associate and/or execute with this shape. Various icons are displayed on the display with the icons representing different instructions, commands, and/or software applications. The user clicks on the icon instruction for opening a software application. Subsequently, when the electronic device senses the user drawing a 2D circle parallel to and adjacent with the display, the electronic device will execute an instruction to open the selected software application.

Consider an example in which a user wears a wearable electronic device that senses and tracks hand movements of the user for a touchless user interface. Movements of a right hand in front of the user control a cursor presented by a display of the wearable electronic device. In order to perform a click operation, the user holds his right index finger and right thumb a fixed distance from each other and then consecutively twice taps this finger and thumb together to execute the click operation.

FIG. 8 is a method to execute an instruction with an electronic device in response to motion of a finger and a thumb.

Block 800 states determine a finger and a thumb oppositely disposed from each other with an electronic device disposed between the finger and the thumb.

The electronic device senses, receives, or determines a position of the finger and the thumb with the electronic device disposed between the finger and the thumb. For example for a right-handed user, the right thumb is positioned on a top surface (such as a display) of the electronic device, and the right index finger of the same hand is positioned on a bottom surface of the electronic device. The top surface faces upwardly toward the user, and the bottom surface faces downwardly away from the user while the finger and the thumb engage or touch the electronic device. As another example for the right-handed user, the right thumb is positioned proximate to and above the top surface (such as above the display) of the electronic device, and the right index finger of the same hand is positioned proximate to and below the bottom surface of the electronic device. The top surface faces upwardly toward the user, and the bottom surface faces downwardly away from the user while the finger and the thumb do not physically engage or touch the electronic device but are positioned in an area or space proximate to the electronic device with the electronic device disposed between the finger and the thumb.

Block 810 states execute a touchless user interface control of the electronic device in response to determining the finger and the thumb oppositely disposed from each other with the electronic device disposed between the finger and the thumb.

The electronic device enters the touchless user interface control mode upon detecting the positions of the finger and the thumb. In this mode, motions or movements of the finger and the thumb and/or other fingers or the other thumb control the electronic device.

Block 820 states determine simultaneous motion of the finger and thumb oppositely disposed from each other with the electronic device disposed between the finger and thumb.

For example, the electronic device senses, receives, or determines locations and movements of the finger and thumb while the electronic device is disposed between the finger and the thumb. For instance, the electronic device tracks locations and/or movements of the finger and thumb.

Block 830 states execute an instruction with the electronic device in response to determining the simultaneous motion of the finger and thumb oppositely disposed from each other with the electronic device disposed between the finger and thumb.

The electronic device determines movement of the finger and the thumb in the touchless user interface control mode, and these movements provide communications, instructions, and/or commands to the electronic device.

Movements of the finger and the thumb occur on or while touching or engaging oppositely disposed surfaces of the electronic device. Alternatively, movements of the finger and the thumb occur proximate to oppositely disposed surfaces of the electronic device without touching or engaging these surfaces.

By way of example, the electronic device senses, receives, or determines movements of the finger and the thumb of a right hand of a user while the user holds the electronic device with a left hand. Alternatively, the user holds the electronic device with the right hand, and the electronic device determines movements of the finger and thumb of the left hand.

Consider an example in which a user holds a tablet computer in her left hand while positioning her right thumb on or above the top surface having a display facing the user and her right index finger on or below the bottom surface. In this position, the tablet computer is between her right thumb and right index finger. The right index finger is hidden under a body of the tablet computer with the top display being face-up and visible to the user and the bottom surface being face-down and not visible to the user. Further, the thumb and the finger are oppositely disposed from each other along a Z-axis that extends perpendicular to the top and bottom surfaces of the tablet computer.

Continuing with this example, a cursor moves along the display of the tablet computer as the user simultaneously moves her thumb and her finger. For example, the cursor appears on the display in a position between the finger and the thumb and tracks or follows movements of the finger and the thumb. As the user moves her finger and thumb with the tablet computer remaining therebetween, the cursor follows these movements and remains between the finger and the thumb. These movements can occur while the finger and the thumb both engage the surfaces of the tablet computer, while the finger engages the top surface and the thumb is proximate to but not engaging the bottom surface, while the finger is proximate to but not engaging the top surface and the thumb engages the bottom surface, or while both the finger and the thumb are proximate to but not engaging the surfaces of the tablet computer.

When the thumb and the finger are not engaging the electronic device but are proximate to it, they can move in various directions along the X-axis, Y-axis, and/or Z-axis (the X-axis and Y-axis being parallel with a body of the electronic device, and the Z-axis being perpendicular to the body). These movements can control the electronic device in the touchless user interface mode. For example, simultaneous movement of the thumb and the finger toward the electronic device along the Z-axis executes a click operation at a location that is disposed between the thumb and the finger.

Consider an example in which a user desires to perform (with a finger and a thumb of a same hand) a drag-and-drop operation on a folder that appears on a display of a tablet computer. While holding the tablet computer with his left hand, the user positions the tablet computer between his right thumb and right index finger with the thumb and finger being proximate to but not touching the tablet computer. The user moves his thumb and finger to a location in which the displayed folder is located between the thumb and the finger (i.e., the thumb, the finger, and the folder are aligned along a line that extends along the Z-axis). The user then simultaneously moves his thumb and his index finger toward the folder along the Z-axis without touching the tablet computer. In response to determining this movement, the tablet computer executes a click on the folder. The user then simultaneously moves his thumb and his index finger in a Y-direction. In response to determining this movement, the tablet computer drags or moves the folder to follow and/or track movement of the thumb and the index finger. The user then simultaneously moves his thumb and his index finger away from the folder along the Z-axis. In response to determining this movement, the tablet computer executes a drop or release of the folder at this location.

Consider an example in which a user holds a smartphone in her left hand with a display of the smartphone facing upward toward the user. The user simultaneously positions the thumb of her right hand above the display and the index finger of her right hand below the display and under the smartphone. The thumb and the index finger are aligned such that the index finger is directly below the thumb. A cursor on the display moves in conjunction with movements of the thumb and the index finger. For instance, the thumb and the index finger move in unison with each other while remaining aligned with each other to move the cursor across the display. This cursor appears on the display at a location that is between the thumb and the index finger. An imaginary perpendicular line drawn through the display would pass through the thumb, the location of the cursor on the display, and the index finger. The cursor exists between the thumb and index finger and remains at this location while the thumb and index finger move in areas adjacent to and parallel with opposite sides of the display visible to the user.

Consider the example above in which the user desires to draw or select a rectangular or square area on the display of the smartphone with her thumb and index finger. The smartphone senses the thumb and index finger simultaneously moving toward the display, and this action instructs the smartphone to active a click with the cursor that is located between the thumb and index finger. Next, the smartphone detects the thumb and index finger moving in opposite directions. For instance, the thumb moves upward in a positive Y direction toward a top of the display, and the index finger moves downward in a negative Y direction toward a bottom of the display. These movements cause a straight line to appear on the display along the Y-axis of the display. This line extends from a location of the cursor and upward toward the top of the display and from the location of the cursor and downward the bottom of the display. The thumb and index finger then simultaneously move parallel with the display and toward a right side of an edge of the display (i.e., they move in a positive X direction that is perpendicular to the Y direction and to the straight line drawn with the upward and downward movements). These movements cause two straight lines to appear on the display in the X direction. One of these straight lines extends from and perpendicular to a top of the line drawn in the Y direction, and one of these straight lines extends from and perpendicular to a bottom of the line drawn in the Y direction. The thumb and the index then simultaneously move parallel with the display and toward each other in the Y direction until the thumb and the index finger are aligned with each other along the Z-axis. These movements cause a straight line to appear on the display along the Y-axis of the display. This line is parallel with the first line drawn along the Y-axis. Together, these four lines form a square or a rectangular area that is selected on the display. The smartphone senses the thumb and index finger simultaneously moving away from the display, and this action instructs the smartphone to active a second click with the cursor to complete the selection of the area drawn on the display with movements of the thumb and index finger.

Electronic devices discussed herein can have multiple displays, such as one or more displays on opposite or adjacent surfaces of the electronic device. For example, a smartphone or tablet computer having a thin rectangular shape can have a first display on a first side and a second display on an oppositely disposed second side. As another example, an electronic device has multiple displays that extend into 3D areas or spaces adjacent to the electronic device.

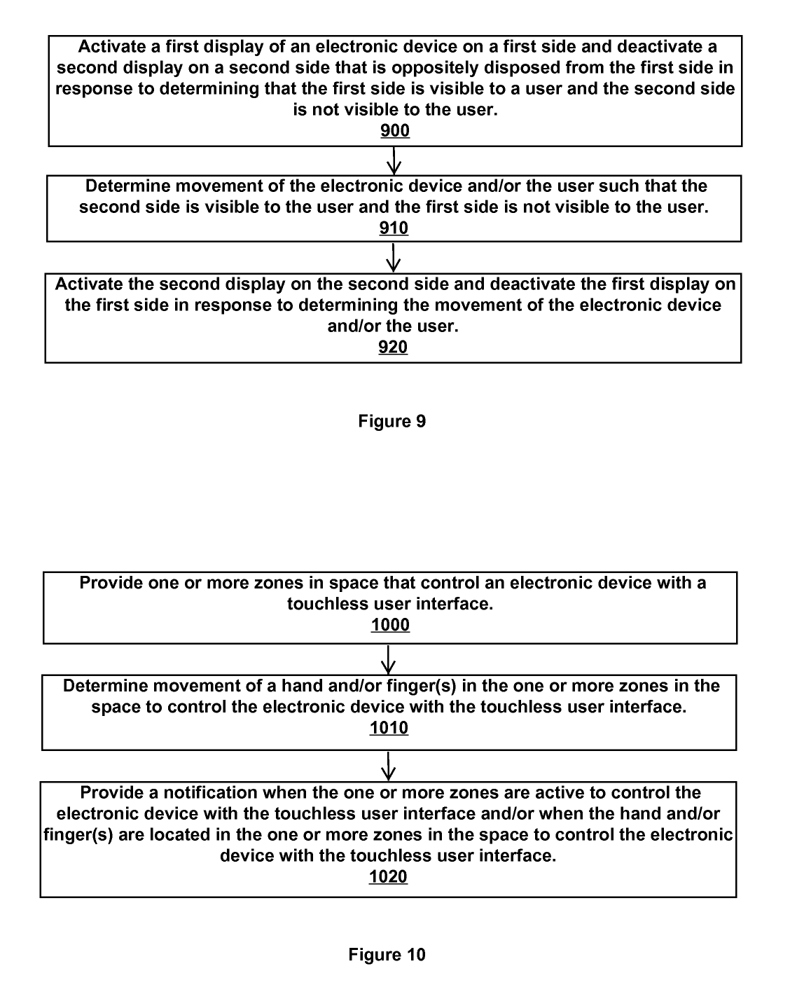

FIG. 9 is a method to activate and to deactivate displays of an electronic device in response to determining movement of the electronic device and/or a user.

Block 900 states activate a first display of an electronic device on a first side and deactivate a second display on a second side that is oppositely disposed from the first side in response to determining that the first side is visible to a user and the second side is not visible to the user.

For example, the electronic device determines, senses, and/or receives a position and/or orientation of the electronic device. Further, the electronic device determines, senses, and/or receives a position and/or orientation of a face, eyes, and/or gaze of the user with respect to the first display and/or the second display.

Block 910 states determine movement of the electronic device and/or the user such that the second side is visible to the user and first side is not visible to the user.

For example, the electronic device determines, senses, and/or receives a different position and/or different orientation of the electronic device. Further, the electronic device determines, senses, and/or receives a different position and/or different orientation of the face, eyes, and/or gaze of the user with respect to the first display and/or the second display.

Block 920 states activate the second display on the second side and deactivate the first display on the first side in response to determining the movement of the electronic device and/or the user.

Consider an example in which a user sits in a chair and holds in his lap a tablet computer that has a first display on a first side and a second display on an oppositely disposed second side. The first display displays a window that plays a movie, and the second display displays a window that shows an Internet website. While the first display is face-up and visible to the user and the second display is face-down and not visible to the user, the first display is active, and the second display is inactive. For instance, the first display plays the movie for the user while the second display is asleep with a black screen. The user then flips the tablet computer over such that the second display is face-up and visible to the user and the first display is face-down and not visible to the user. In response to sensing this flipping motion, the tablet computer pauses the movie, deactivates the first display to a black screen, activates the second display, and refreshes the Internet website displayed on the second display.

Consider an example in which a smartphone with a thin rectangular body has a first display on its first side and a second display on its second side. A user holds the smartphone with a right hand and views the first display that plays a video. The smartphone tracks eye movement of the user and maintains the first display active playing the video while the eyes of the user view the first display. During the time that the first display is active, the second display is inactive since the eyes of the user view the video playing on the first display and not the second display. While holding the smartphone still, the user moves his head and/or body such that his eyes change from viewing the first display to viewing the second display. In response to determining that the eyes of the user switched from viewing the first display to viewing the second display, the smartphone deactivates the first display and activates the second display to play the video. The second display plays the video that was previously playing on the first display. This video plays continuously or in an interrupted fashion from playing on the first display to playing on the second display. Switching of the video from playing on the first display to playing on the second display coincides with or tracks switching of the user from viewing the video on the first display to viewing the video on the second display.

Consider an example in which two different users are authorized to use a tablet computer that has a thin rectangular body with a first display on its first side and a second display on its second side. The first user holds the tablet computer in front of himself and views a movie playing on the first display on the first side. The second side with the second display faces away from the first user and is off and/or not active. During this time, the second user comes proximate to the tablet computer and views the second display. The tablet computer performs a facial recognition of the second user and recognizes this second user as being authorized to use the tablet computer. In response to this recognition and authorization, the tablet computer turns on or activates the second display such that the movie simultaneously plays on the first display for the first user and on the second display for the second user.

Consider an example in which a HPED has a first side with a first display and a second side with a second display. A physical configuration of the first side is similar to a physical configuration of the second side such that the HPED has no predetermined front or back. The front side and the back side emulate each other and include a user interface. While the HPED is located in a pocket of the user, the front and second displays are off or inactive. When the user pulls the HPED out of the pocket, the side closest to the face of the user turns on or activates. For instance, if the user holds the HPED such that the second side is visible to the eyes of the user, then the second display turns on or becomes active while the first display is off or remains inactive. When the user flips the HPED such that the first side is visible to the eyes of the user, then the first display turns on or becomes active while the second display transitions to an off state or inactive state. Flipping the HPED can activate and deactivate the displays.

FIG. 10 is a method to determine movement of a hand and/or finger(s) in a zone provided in space to control an electronic device with a touchless user interface.

Block 1000 states provide one or more zones in space that control an electronic device with a touchless user interface.

The one or more zones appear or exist in 3D space and visually distinguish or identify an area that controls the electronic device through the touchless user interface. An outline or border shows a boundary for the zones. For example, the zones are projected into the space or appear on a display to be in the space. For instance, wearable electronic glasses include a display that displays a zone, and this zone appears to be located in an area located next to the wearer of the glasses. As another example, the zones are provides as part of an augmented reality system in which a view of the real physical world is augmented or modified with computer or processor generated input, such as sound, graphics, global positioning satellite (GPS) data, video, and/or images. Virtual images and objects can be overlaid on the real world that becomes interactive with users and digitally manipulative.

Zone areas are distinguished from surrounding non-zone area using, for example, color, light, shade, etc. Such zones can be virtual and provided with a non-physical barrier.

Block 1010 states determine movement of a hand and/or finger(s) in the one or more zones in the space to control the electronic device with the touchless user interface.

Movement of one or more hands and and/or fingers in the zones controls the electronic device through the touchless user interface. For example, areas or space of the zones correspond with one or more sensors that sense motion within the zones. The sensors sense hand and/or finger movements in the zones, and these movements are interpreted to provide instructions to the electronic device.

Block 1020 states provide a notification when the one or more zones are active to control the electronic device with the touchless user interface and/or when the hand and/or finger(s) are located in the one or more zones in the space to control the electronic device with the touchless user interface.

The electronic device provides a visual and/or audible notification when a user interacts or engages or disengages a zone and/or when a zone is active, activated, de-active, and/or de-activated. This notification enables a user to determine when the zone is active and/or inactive for the touchless user interface and/or when movements (such as movements from the user's hands, fingers, or body) are interacting with the electronic device through the touchless user interface. As one example, a visual notification appears on a display of the electronic device and notifies the user (such as text, light, or indicia being displayed on or through the display). As another example, the zone itself changes to notify the user. For instance, the zone changes its color, intensifies or dims its color, becomes colored, changes from being invisible to visible, changes or adds shade that fills the zone, or uses light to outline or detail a border or content of the zone. As another example, the electronic device generates a sound (such as a beep or other noise) when a hand and/or finger enter the zone to communicate with the electronic device or leave the zone after communicating with the electronic device.

The notification includes a map, diagram, image, or representation of the zone and an image or representation of a finger, hand, or other body part physically located in the zone. For instance, a display displays an image of the zone and an image or representation of the user's real finger located inside of the zone. The image or representation of the finger tracks or follows a location of the real finger as the real finger moves in the zone.

Consider an example in which an HPED includes a touchless user interface that has a zone extending outwardly as a three dimensional shape from a surface of the HPED. This zone is invisible to a user and defines an area into which the user can perform hand and/or finger gestures to communicate with the HPED. An image or representation of this zone appears on the display of the HPED. For instance, the image of the zone on the display has a shape that emulates a shape of the real zone that extends outwardly from the HPED. The image of the zone also includes an image or representation of the finger of the user (such as a virtual finger, a cursor, a pointer, etc.). When the user places his finger in the real zone located above the HPED, the image or representation of the finger appears in the image of the zone on the HPED. Further, as the finger in the real zone moves around in the real zone, the image or representation of the finger moves around in the image of the zone on the display. A location of the image or representation of the finger in the image of the zone tracks or follows a location of the real finger in the real zone. Furthermore, the image of the zone activates or appears on the display when the user places his finger inside the zone and de-activates or disappears from the display when the user removes his finger from the zone.

Consider an example in which a pair of wearable electronic glasses includes a touchless user interface that has a three dimensional zone located adjacent a body of a wearer of the wearable electronic glasses. The zone defines an area in space into which the wearer performs hand and/or finger gestures to communicate with the wearable electronic device. The zone is not visible to third parties, such a person looking at the wearer wearing the glasses. A display of the glasses displays to the wearer a rectangular or square image that represents the zone and the area defined by the zone. When the user places his hand inside of the zone, a pointer appears on the display and in the image that represents the zone. The user can visually discern from the display when his finger is located in the zone and where his finger is located in the zone. For instance, an X-Y-Z coordinate location of the pointer in the displayed zone corresponds, emulates, and/or tracks an X-Y-Z coordinate location of the real finger in the real zone.

Consider an example in which a user controls an electronic device via a touchless user interface in a 3D zone that extends into an area outwardly and from a surface of the electronic device. The zone is invisible to the user when the zone is inactive and becomes visible to the user when active or engaged. The touchless user interface is configured to respond to hand movements of the user when the hand is located inside an area defined by the zone. When a hand of a user is not located in the zone, then the zone is invisible to the user and not active to receive hand gestures to control the electronic device. When the hand of the user enters or moves to a location that is within the zone, then the zone becomes visible to the user and is active to receive hand gestures to control the electronic device. In this manner, a user knows or is aware when his or her hand movements will control and/or communicate with the electronic device. This prevents the user from accidentally or unintentionally making hand gestures that instruct the electronic device. For example, when the hand of the user moves into the space of the zone, a boundary or area of the zone highlights or illuminates so the user can visually determine where the zone exists or extends in space. This highlight or illumination also provides the user with a visual notification that the zone is active and that hand movements are now being sensed to communicate with the electronic device via the touchless user interface.

Consider an example in which an HPED projects a 3D zone in a space that is located above a surface of its display. This zone provides a touchless user interface in which a user provides gestures to communicate with the HPED. The zone extends outwardly from the display as a cube, box, or sphere. An intensity of a color of the zone increases when a finger and/or hand of the user physically enter the zone to communicate with the HPED via the touchless user interface. The intensity of the color of the zone decreases when the finger and/or hand of the user physically leave the zone to finish or end communicating with the HPED via the touchless user interface.

Consider an example in which a user wears a pair of electronic glasses that include lenses with a display. The lenses and/or display provide a 3D rectangular zone that appears to be located in front of the wearer. This zone is outlined with a colored border (such as green, black, or blue light) and defines an area through which the wearer uses hand and/or finger movements to interact with the electronic glasses. This colored border provides the user with a visual demarcation for where the touchless user interface starts and stops. The wearer thus knows where in space to move his hands in order to communicate with the electronic glasses. When the wearer moves his hands through the zone, the electronic glasses sense these movements and interpret a corresponding instruction from the movements. By contrast, when the user moves his hands outside of the zone, the electronic glasses ignore hand movements or do not sense such hand movements since they occur outside of the zone. Further, a boundary of the zone remains dimly lit when a hand of the user is located outside of the zone. While dimly lit, the user can see where the zone exists in space but also see through the zone (e.g., see physical objects located outside of or behind the zone). The boundary of the zone intensifies in color and/or changes color when the hand of the user is located inside of the zone. Thus, a user can change a color and/or intensity of light with which the zone is illuminated by moving his hand into and out of the area defined by the zone.

Consider an example in which a user wears a wearable electronic device that projects or provides an image of a zone that extends in space next to the wearable electronic device. This zone provides an area in which the user can control a tablet computer that is remote from the user and the wearable electronic device. Using a touchless user interface, the user makes finger gestures in the zone. These gestures perform actions on the remote tablet computer, such as moving a cursor, performing drag-and-drop operations, opening and closing software applications, typing, etc. A light turns on or activates on a display of the wearable electronic device when the touchless user interface is on and/or active in order to provide the user with a visual notification of this on and/or active state.

Consider an example in which a tablet computer projects a zone or boundary in 3D space above its display. This boundary includes an image (such as a holographic image, light image, or laser image) that indicates an area for interacting with the tablet computer via a touchless user interface. Movements of a user inside this area provide instructions to the tablet computer. The boundary is inactive and thus invisible when or while a body of the user is not located inside the 3D space. The boundary and image activate, turn on, and/or illuminate when or while a body part of the user is located inside the 3D space.

FIG. 11 is a method to display with a wearable electronic device a display of another electronic device and a zone to control the other electronic device with a touchless user interface.

Block 1100 states display with a wearable electronic device a display of a remote electronic device along with one or more zones in space that control the remote electronic device through a touchless user interface.

The wearable electronic device simultaneously provides the display of the remote electronic device and one or more zones that control the remote electronic device. For example, a desktop configuration of the remote electronic device appears on or as the display of the wearable electronic device. A zone to control this desktop configuration also appears on or as the display of the wearable electronic device. The touchless user interface provides an interface for a user to control the remote electronic device with the wearable electronic device.

Block 1110 states determine movement of a hand and/or finger(s) in the one or more zones in the space to control the remote electronic device with the touchless user interface.

Movement of one or more hands and and/or fingers in the zones controls the remote electronic device through the touchless user interface. For example, areas or space of the zones correspond with one or more sensors that sense motion within the zones. The sensors sense hand and/or finger movements in the zones, and these movements are interpreted to provide instructions to the remote electronic device.

Consider an example in which a user wears a pair of electronic glasses with a display that displays a desktop of a notebook computer of the user along with a zone in space for interacting with the notebook computer. The electronic glasses simultaneously display the desktop and a zone in which hand gestures remotely control and/or interact with the notebook computer that is remotely located from the user and the electronic glasses. Hand and/or finger gestures in the zone enable the user to remotely communicate with and control the remotely located notebook computer. The zone is displayed as a 3D box in space located in front of the user and/or electronic glasses. Color or shading distinguishes the shape, size, and location of the box so the user knows where to place his hands in order to provide instructions through a touchless user interface. For example, the zone appears with a colored border or is filled with a visually discernable shade, color, or indicia.

Consider an example in which a remote desktop application includes a software or operating system feature in which a desktop environment of a personal computer executes remotely on a server while being displayed on a wearable electronic device. The wearable electronic device remotely controls the desktop of the personal computer. The controlling computer (the client) displays a copy of images received from the display screen of the computer being controlled (the server). User interface commands (such as keyboard, mouse, and other input) from the client transmit to the server for execution as if such commands were input directly to the server.

Consider an example in which a desktop configuration of a personal computer is shared with wearable electronic glasses using real-time collaboration software application. The wearable electronic glasses simultaneously display a desktop configuration of the personal computer and a touchless user interface zone that provides an interface for communicating with the personal computer.

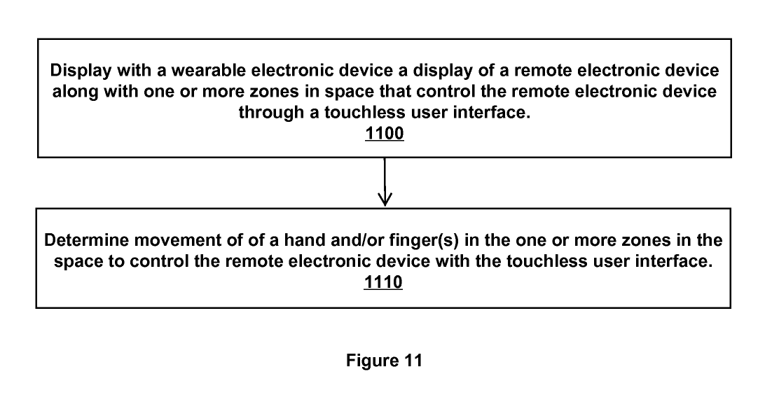

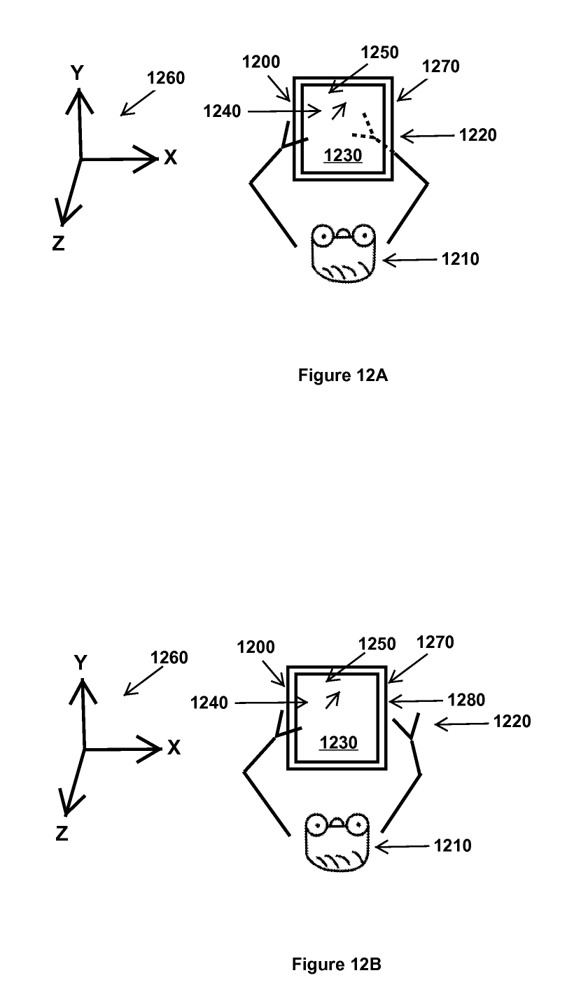

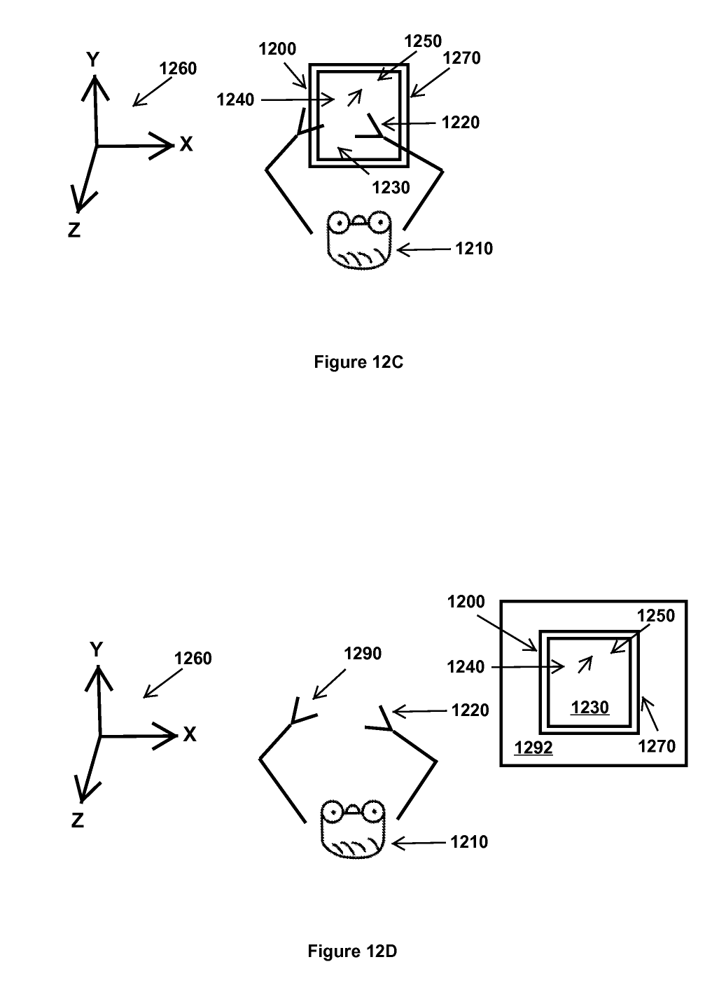

FIGS. 12A-12D illustrate an electronic device 1200 in which a user 1210 controls the electronic device through a touchless user interface with a hand and/or finger(s) 1220. For illustration, the electronic device has a display 1230 with a cursor or pointer 1240 on a front side or front surface 1250 and is shown in an X-Y-Z coordinate system 1260.

FIG. 12A shows the hand and/or finger(s) 1220 in a right hand controlling the electronic device 1200 from a backside or back surface 1270 that is oppositely disposed from the front side 1250 while the user 1210 holds the electronic device in a left hand. The user 1210 holds the electronic device 1200 with the front surface 1250 visible to the user 1210 while the hand and/or finger(s) 1220 are adjacent the back surface 1270 and hidden to the user behind a body of the electronic device 1200. Movements of the hand and/or finger(s) 1220 in the X-Y-Z directions control the cursor 1240. Such movements and control can occur without the hand and/or finger(s) 1220 touching the back surface 1270 or body of the electronic device.

FIG. 12B shows the hand and/or finger(s) 1220 in a right hand controlling the electronic device 1200 from a side or side surface 1280 that forms along a periphery or edge of the body of the electronic device while the user 1210 holds the electronic device in a left hand. The user 1210 holds the electronic device 1200 with the front surface 1250 visible to the user 1210 while the hand and/or finger(s) 1220 are adjacent the side surface 1280. Here, a body of the electronic device is neither above nor below the hand and/or finger(s) 1220 but located to one side of the hand and/or finger(s) 1220. Movements of the hand and/or finger(s) 1220 in the X-Y-Z directions control the cursor 1240. Such movements and control can occur without the hand and/or finger(s) 1220 touching the back surface 1270 or body of the electronic device.

FIG. 12C shows the hand and/or finger(s) 1220 in a right hand controlling the electronic device 1200 from the front side or front surface 1250 while the user 1210 holds the electronic device in a left hand. The user 1210 holds the electronic device 1200 with the front surface 1250 visible to the user 1210 while the hand and/or finger(s) 1220 are adjacent the front surface 1250 and above the display 1230. Movements of the hand and/or finger(s) 1220 in the X-Y-Z directions control the cursor 1240. Such movements and control can occur without the hand and/or finger(s) 1220 touching the front surface 1250 or body of the electronic device.

FIG. 12D shows the hand and/or finger(s) 1220 in a right hand and/or the hand and/or finger(s) 1290 in a left hand controlling the electronic device 1200 from the front side or front surface 1250 while the back side or back surface 1270 of the electronic device rests on a table 1292. The user 1210 can be proximate to the electronic device (such as the user being able to see the electronic device) or remote from the electronic device (such as the user being located in another room, another building, another city, another state, another country, etc.). Movements of the hand and/or finger(s) 1220 and 1290 in the X-Y-Z directions control the cursor 1240. Such movements and control can occur without the hand and/or finger(s) 1220 and 1290 touching the front surface 1250 or body of the electronic device.

By way of example in the X-Y-Z coordinate system 1260, the X axis extends parallel with the display 1230 from left-to-right; the Y axis extends parallel with the display 1230 from top-to-bottom; and the Z axis extends perpendicular to the display 1230. Hand and/or finger movements along the X axis or X direction cause the cursor to move along the X axis or X direction on the display, and hand and/or finger movements along the Y axis or Y direction cause the cursor to move along the Y axis or Y direction on the display. Hand and/or finger movements along the Z axis or Z direction cause a click or tap to occur at the location of the cursor on the display.

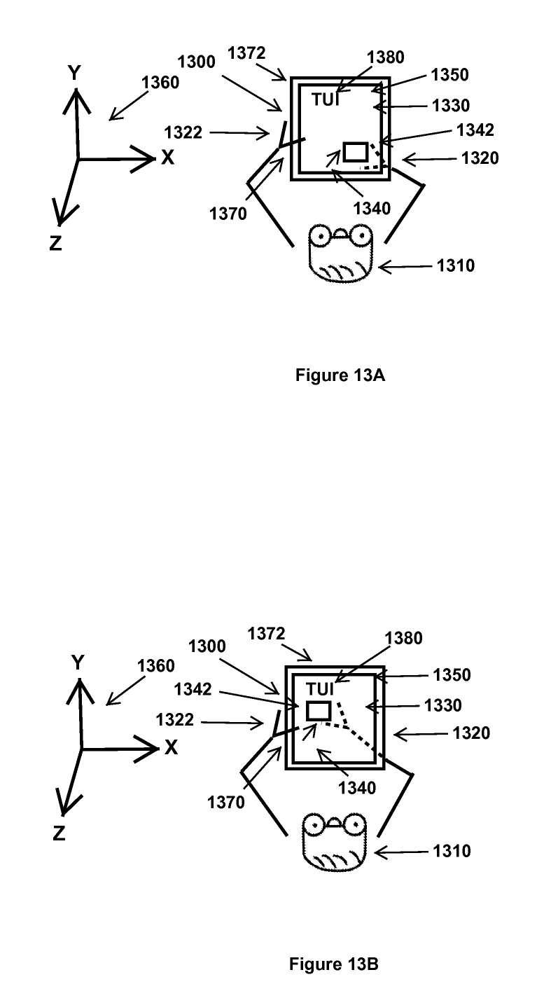

FIGS. 13A and 13B illustrate an electronic device 1300 in which a user 1310 controls the electronic device through a touchless user interface with a hand and/or finger(s) 1320 of a right hand while a left hand 1322 holds the electronic device. For illustration, the electronic device has a display 1330 with a cursor or pointer 1340 and an object 1342 on a front side or front surface 1350 and is shown in an X-Y-Z coordinate system 1360.

Activation of the touchless user interface occurs when the electronic device 1300 determines, senses, or receives an action from the user. As one example, the electronic device enters into or exits from control via the touchless user interface when the electronic device sense the hand and/or finger(s) 1320 moving in a predetermined sequence. For instance, when the electronic device senses a user speaking a certain command and/or senses fingers of the user moving across the display in a predetermined manner or shape, the electronic device enters into a mode that controls the electronic device via the touchless user interface.

As another example, activation of the touchless user interface occurs when the electronic device senses a hand of the user physically gripping or physically holding the body of the electronic device at a predetermined location. For instance, the electronic device activates the touchless user interface when the user holds the electronic device at a predetermined location 1370 that exists on a periphery or edge of a body of the electronic device. This location 1370 can be an area on the front side or front surface 1350 and/or an area on the back side or back surface 1372. When the user grabs the electronic device at location 1370, the electronic device initiates or activates the touchless user interface. When the user removes his or her hand from the location 1370, the electronic device stops or de-activates the touchless user interface. The user can grip or hold the electronic device without turning on or activating the touchless user interface. For example, when the user holds the electronic device at areas outside of the location 1370, the touchless user interface remains off or inactive.

As another example, activation of the touchless user interface occurs when the electronic device senses a hand of the user physically gripping or physically holding the body of the electronic device with a predetermined hand and/or finger configuration. For instance, the electronic device activates the touchless user interface when the user holds the electronic device with a thumb on the front side or front surface 1350 and two fingers on the back side or back surface 1372. In this instance, activation of the touchless user interface occurs upon sensing a predetermined finger configuration (e.g., a thumb on one side and two fingers on an oppositely disposed side). Other predetermined hand and/or finger configurations exist as well (such as one thumb and one finger, one thumb and three fingers, one thumb and four fingers, two thumbs and multiple fingers, etc.). Further activation of the touchless user interface based on a predetermined hand and/or finger configuration can occur at a specific or predetermined location (such as location 1370) or at any or various locations on the body of the electronic device. When the user grabs the electronic device with the predetermined hand and/or finger configuration, the electronic device initiates or activates the touchless user interface. When the user removes his or her hand or changes the grip from the predetermined hand and/or finger configuration, the electronic device stops or de-activates the touchless user interface. The user can grip or hold the electronic device without turning on or activating the touchless user interface. For example, when the user holds the electronic device without using the predetermined hand and/or finger configuration, the touchless user interface remains off or inactive.

Activation and deactivation of the touchless user can occur without the user physically gripping or physically holding the electronic device at a predetermined location or with a predetermined hand and/or finger configuration. Instead, activation and deactivation of the touchless user interface occurs in response to holding a hand and/or finger(s) at a predetermined location away from the electronic device and/or the user holding a hand and/or finger with a predetermined configuration away from the electronic device.

As an example, activation of the touchless user interface occurs when the electronic device senses a hand and/or finger(s) of the user at a predetermined location that is away from or remote from the electronic device. For instance, the electronic device activates the touchless user interface when the user holds his hand one to three inches above or adjacent the front side or front surface 1350 and/or the back side or back surface 1372. This location can be a specific area in space with a predetermined size and shape (such as a cylindrical area, a spherical area, a rectangular area, or a conical area adjacent or proximate a body of the electronic device). When the user holds his hand and/or fingers in or at this location, the electronic device initiates or activates the touchless user interface. When the user removes his or her hand from this location, the electronic device stops or de-activates the touchless user interface.

As an example, activation of the touchless user interface occurs when the electronic device senses a hand and/or finger(s) of the user with a predetermined hand and/or finger configuration at a location that is away from or remote from the electronic device. For instance, the electronic device activates the touchless user interface when the user holds his left hand adjacent to the electronic device with his left hand being in a first shape (e.g., with the thumb and fingers clenched), with his left hand and fingers showing a circle (e.g., the thumb and index finger touching ends to form a circle), with his left hand and fingers being flat (e.g., the thumb and fingers in an extended handshake configuration), or with this left hand showing a number of fingers (e.g., extending one finger outwardly to indicate a number one, extending two fingers outwardly to indicate a number two, extending three fingers outwardly to indicate a number three, or extending four fingers outwardly to indicate a number four). Various other hand and/or finger configurations can occur as well. When the user holds his hand and/or fingers with the predetermined hand and/or finger configuration, the electronic device initiates or activates the touchless user interface. When the user changes his or her hand from the predetermined hand and/or finger configuration, the electronic device stops or de-activates the touchless user interface. For example, the user holds his left hand in the predetermined hand and/or finger configuration to activate the touchless user interface and then uses his right hand to communicate and control the electronic device via the touchless user interface. The touchless user interface remains active while the left hand remains in this predetermined hand and/or finger configuration and ceases when the left hand ceases to maintain the predetermined hand and/or finger configuration.

The electronic device 1300 provides a visual or audible notification to notify a user of activation and/or deactivation of the touchless user interface. For example, text or indicia 1380 appears on the display while the touchless user interface is active or on. For illustration, this text 1380 is shown as “TUI” (an acronym for touchless user interface).

Consider an example in which an HPED senses a first hand of the user with fingers in a predetermined configuration while the first hand is located away from a body of the HPED and not touching the body of the HPED. The HPED activates a touchless user interface in response to sensing the first hand of the user with the fingers in the predetermined configuration while the first hand is located away from the body of the HPED and not touching the body of the HPED. With the first hand in this predetermined configuration, the user controls and/or communicates with the HPED. For example, the HPED senses a second hand of the user moving to instruct the HPED via the touchless user interface while the first hand of the user and the fingers remain in the predetermined configuration while the first hand is located away from the body of the HPED and not touching the body of the HPED. This touchless user interface remains active while the first hand of the user and the fingers remain in the predetermined configuration while the first hand is located away from the body of the HPED and not touching the body of the HPED. When the HPED senses removal of the first hand and/or a change of this hand to no longer have the predetermined configuration, then the HPED deactivates or ceases the touchless user interface.

The electronic device 1300 enables a user to move an object 1342 on the display 1330 without touching the electronic device. For example, FIG. 13A shows a right hand and/or finger(s) 1320 of the user 1310 being located behind the electronic device such that the hand and/or finger(s) 1320 are hidden or not visible to the user 1310. From this backside location, the hand and/or finger(s) 1320 select the object 1342 with the cursor 1340 and then move the object from a first location near a bottom of the display 1330 (shown in FIG. 13A) to a second location near a top of the display 1330 (shown in FIG. 13B).

By way of example, the electronic device 1300 senses movement of the hand and/or finger(s) 1320 along the X-Y axes while the hand and/or finger(s) are hidden behind the electronic device and not visible to the user. These motions along the X-Y axes move the cursor 1340 along the X-Y axes of the display 1330 until the cursor is positioned at the object 1342. Movement of the hand and/or finger(s) 1320 along the Z-axis initiates a click action on the object 1342 to select or highlight the object. Movement of the hand and/or finger(s) 1320 along the X-Y axes moves the cursor 1340 and the object 1342 to a different location on the display 1330. Movement of the hand and/or finger(s) 1320 along the Z-axis initiates a second click action on the object 1342 to unselect or un-highlight the object. This second movement along the Z-axis releases the object at the different location on the display. These movements along the X-Y-Z axes function to perform a drag-and-drop operation of the object 1342 on the display 1330.

The object 1342 on the display can also be moved with touches or taps to a body of the electronic device 1300. For example, the electronic device senses a touch or tap on the back surface 1372 while the front surface 1350 and display 1342 are visible to the user 1310 and the back surface 1372 is not visible to the user (e.g., not in a line of sight of the user and/or obstructed from view). This touch or tap occurs on the back surface at a location that is oppositely disposed from and directly under the object 1342 while the front surface 1350 and display 1342 are visible to the user 1310 and the back surface 1372 is not visible to the user. Without removing the hand and/or finger(s) 1320 that performed the touch on the back surface 1372, the hand and/or finger(s) drag across the back surface 1372 and contemporaneously move the object 1342. When the object 1342 is at a desired location, the hand and/or finger(s) disengage from the back surface 1372 and release the dragged object at the different location. Removal of the hand and/or finger(s) 1320 from the back surface 1372 activates a second click or release of the object upon completion of the drag movement.

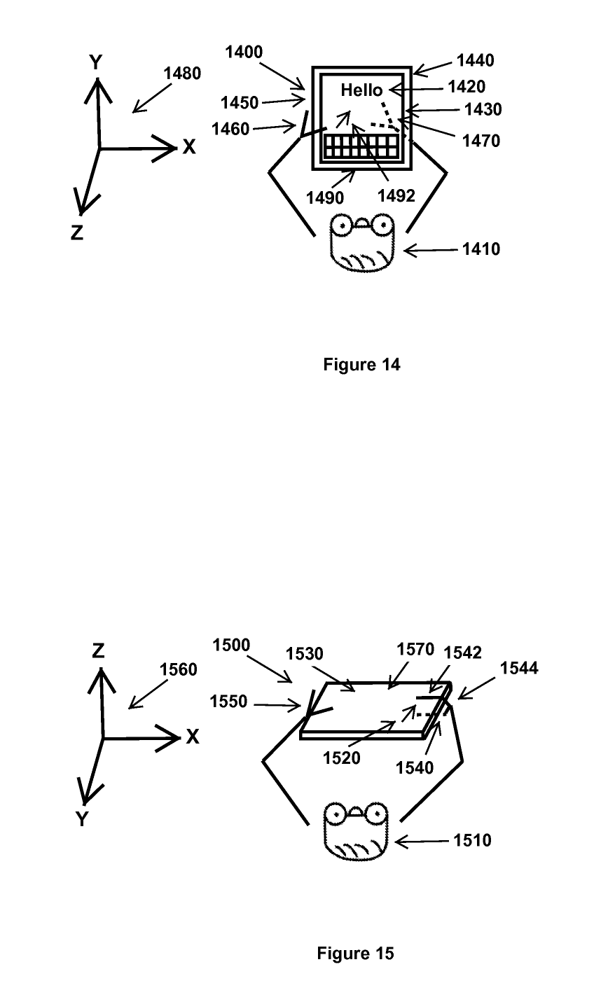

FIG. 14 illustrates an electronic device 1400 in which a user 1410 enters text 1420 on a display 1430 located on a front side or front surface 1440 through a touchless user interface from a back side or back surface 1450. For illustration, the user 1410 holds the electronic device 1400 with a left hand 1460 while hand and/or finger(s) 1470 of a right hand type text onto the display 1430. For illustration, the electronic device 1400 is shown in an X-Y-Z coordinate system 1480.

The hand and/or finger(s) 1470 of the right hand are not visible to the user 1410 while text is being entered since a body of the electronic device blocks a view of the hand and/or finger(s) 1470. Further, the electronic device 1400 is shown in a vertical or upright position with the front side 1440, the display 1430 facing toward the user, the back side 1450 facing away from the user, and the display 1430 being in the X-Y plane with the Z-axis extending toward the user and parallel with the ground on which the user is standing.

The display 1430 includes a virtual keyboard 1490 and a pointing device 1492 that track movement and a location of the hand and/or finger(s) 1470 as they move along the back side 1450. For example, when the user is typing with his right index finger, the pointing device 1492 tracks movement of this finger as it moves in space adjacent to the back side 1450. In this manner, a user can visually see a location of his finger. For instance, movement of the finger in the X-Y axes along the back side 1450 simultaneously moves the pointing device 1492 on the display 1430 of the front side 1440. When the finger is over a desired letter of the virtual keyboard 1490, the user can see the pointing device 1492 at this location and/or see that his finger is over this letter (e.g., a letter becomes highlighted or visually distinguishable from other letters when the finger is directly under the letter). Movement of the finger along the Z-axis activates a click on the selected letter. This activation and/or selection can occur without the user touching the back side 1450 or body of the electronic device and can occur while the finger is not visible to the user.

FIG. 15 illustrates an electronic device 1500 in which a user 1510 controls a pointing device 1520 located on a display 1530 with a finger 1540 and a thumb 1542 of a hand 1544 while the electronic device is positioned between the finger 1540 and the thumb 1542. For illustration, the user 1510 holds the electronic device 1500 with a left hand 1550 while the finger 1540 and the thumb 1542 of the right hand 1544 control movement of the pointing device 1520 through a touchless user interface. The electronic device 1500 is shown in an X-Y-Z coordinate system 1560 with a body of the electronic device 1500 positioned in the X-Y plane and with the Z-axis extending perpendicular through the body.

The display 1530 includes the pointing device 1520 that exists between the finger 1540 and the thumb 1542 such that the finger 1540, the thumb 1542, and the pointing device 1520 exist on a single line along the Z-axis. The pointing device 1520 tracks movement of the finger 1540 and the thumb 1542 as they move with the body of the electronic device 1500 existing between them. As the user 1510 moves his finger 1540 and his thumb 1542 along the X-Y axes with the electronic device positioned therebetween, the pointing device 1520 simultaneously moves along the X-Y axes while remaining aligned with the finger and thumb.

Movement of the finger 1540 and/or thumb 1542 along the Z-axis activates or initiates a click or selection at a location of the pointing device 1520. For example, simultaneous movement of the finger and the thumb along the Z-axis toward the body of the electronic device activates a click on an object 1570 being displayed. Movement of the finger and the thumb along the X-Y axes moves or drags the object to a different location on the display. Simultaneous movement of the finger and the thumb along the Z-axis away from the body of the electronic device de-activates or releases the click on the object to effect a drag-and-drop operation of the object.

Consider an example in which a tablet computer includes one or more sensors that sense a position of an index finger and a thumb of a hand that communicate with the tablet computer via a touchless user interface. Simultaneous movements of the index finger and the thumb provide instructions through the touchless user interface while the tablet computer is located between the finger and thumb (e.g., the thumb is located on a top or front side while the index finger is located on a bottom or back side of the tablet computer). A cursor on a display of the tablet computer tracks or follows a position of the thumb as the thumb moves through space above the display. Movement of the index finger along the Z-axis toward the tablet computer activates a click or selection action, and movement of the index finger along the Z-axis away from the tablet computer de-activates or de-selects the click action. Thus, the thumb controls movement of the cursor, and the index finger controls selections or clicks. Alternatively, functions of the thumb and index finger can be switched such that the cursor follows the index finger as it moves along a back side of the display, and the thumb activates or controls click or selection operations.

The touchless user interface can designate certain instructions and/or commands to specific fingers and/or hands. For example, one or more fingers and/or thumbs on a top side or front surface of an electronic device activate and de-activate click operations, and one or more fingers and/or thumbs on a back side or back surface control operation of a pointing device or provide other instructions to the electronic device. For instance, index finger movements along a back side of an HPED control movement of a cursor and move in predetermined configurations or patterns to enter touchless user interface commands, and thumb movements along a front side of the HPED control click or selection operations of the cursor. As another example, one or more fingers and/or thumbs on a top side or front surface of an electronic device control operation of a pointing device or provide other instructions to the electronic device, and one or more fingers and/or thumbs on a back side or back surface activate and de-activate click operations. For instance, index finger movements along a back side of an HPED control click or selection operations of a cursor, and thumb movements along a front side of the HPED control movement of a cursor and move in predetermined configurations or patterns to enter touchless user interface commands. As another example, the cursor tracks or follows movement of a right index finger through space around the electronic device while a left index finger activates click operations. The electronic device ignores or excludes movements of the other fingers since the right index finger is designated for cursor operations and the left index finger is designated for click operations.

The electronic device can also designate specific sides or areas for certain instructions and/or commands. For example, a back surface and/or area adjacent the back surface of an HPED are designated for controlling a cursor and inputting gesture-based commands, while a front surface and/or area adjacent the front surface of the HPED are designated for inputting click operations. As another example, a back surface and/or area adjacent the back surface of an HPED are designated for inputting click operations, while a front surface and/or area adjacent the front surface of the HPED are designated for controlling a cursor and inputting gesture-based commands.

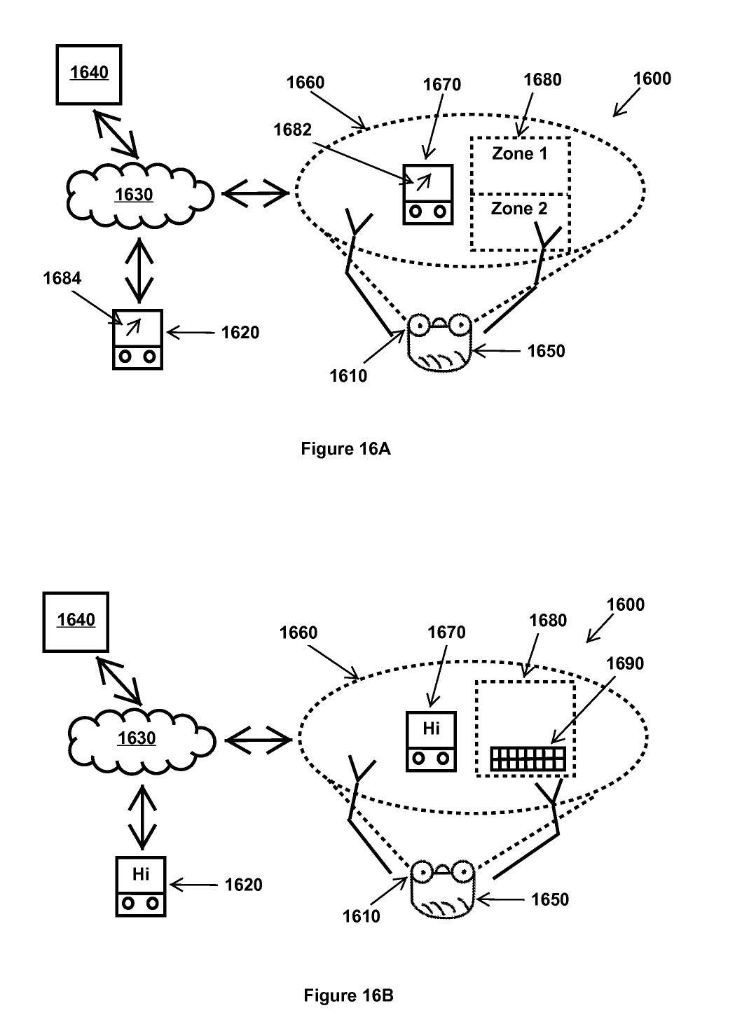

FIGS. 16A and 16B illustrate a computer system 1600 that uses a touchless user interface with a wearable electronic device 1610 to control a remote electronic device 1620 through one or more networks 1630 that communicates with a server 1640. A user 1650 wears the wearable electronic device 1610 and has a line-of-sight or field of vision 1660 that includes a virtual image 1670 of the remote electronic device 1620 and one or more touchless user interface control zones 1680.

In FIG. 16A, the touchless user interface control zones 1680 include two zones (shown as Zone 1 and Zone 2). These zones exist in an area of space adjacent to the user 1650 and/or wearable electronic device 1610 and provide an area for providing instructions and/or commands via a touchless user interface. The virtual image 1670 includes an image of a display of the remote electronic device 1620. When the user moves a cursor 1682 on the virtual image 1670, a cursor 1684 moves on the remote electronic device 1620. The user 1650 can remotely control the remote electronic device 1620 with hand and/or finger gestures through the touchless user interface of the wearable electronic device 1610.

In FIG. 16B, the touchless user interface control zones 1680 include a virtual keyboard 1690. The virtual image 1670 includes an image of a display of the remote electronic device 1620. The user interacts with the virtual keyboard 1690 to simultaneously type into the display of the virtual image 1670 and into the display of the remote electronic device 1620. For instance, typing the world “Hi” into the virtual keyboard 1690 makes the word “Hi” to appear on the virtual image 1670 and on the real remote electronic device 1620.

Consider an example in which a display of a remote HPED is duplicated on a display of wearable electronic device. A user wearing the wearable electronic device interacts with a touchless user interface to control the display of the remote HPED and input instructions that the HPED executes.

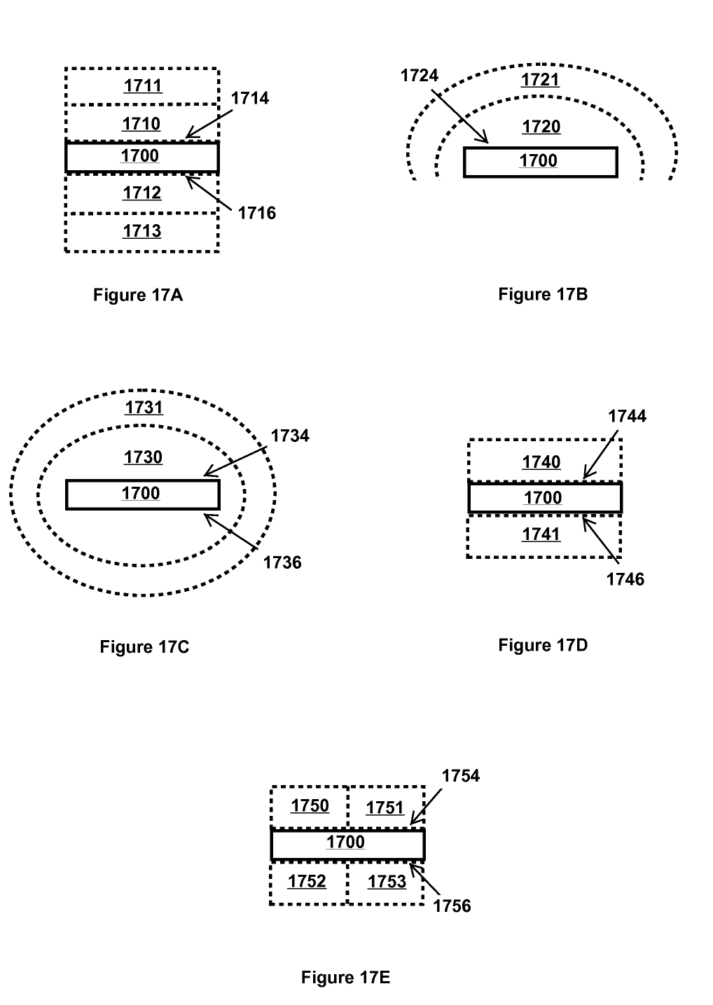

FIGS. 17A-17E illustrate side-views of a rectangular shaped electronic device 1700 with different configurations of 3D zones that control the electronic device via a touchless user interface. These zones can have various sizes, shapes, and functions (some of which are illustrated in FIGS. 17A-17E).

FIG. 17A illustrates the electronic device 1700 with four zones 1710, 1711, 1712, and 1713. Zones 1710 and 1711 extend outwardly from one surface 1714 (such as a top or front surface), and zones 1712 and 1713 extend outwardly from another surface 1716 (such as a bottom or back surface that is oppositely disposed from the front surface). The zones have a 3D rectangular or square configuration that emulates a rectangular or square configuration of a body of the electronic device 1700. Further, the zones are layered or positioned adjacent each other. Zone 1710 is adjacent to and extends from surface 1714, and zone 1711 is positioned on top of or adjacent zone 1710 such that zone 1710 is between zone 1711 and the surface 1714 of the body of the electronic device 1700. Zone 1712 is adjacent to and extends from surface 1716, and zone 1713 is positioned on top of or adjacent zone 1712 such that zone 1712 is between zone 1713 and the surface 1716 of the body of the electronic device 1700.

FIG. 17B illustrates the electronic device 1700 with two zones 1720 and 1721 that extend outwardly from one surface 1724 (such as a top or front surface). The zones have a hemi-spherical configuration. Further, the zones are layered or positioned adjacent each other. Zone 1720 is adjacent to and extends from surface 1724, and zone 1721 is positioned on top of or adjacent zone 1720 such that zone 1720 is between zone 1721 and the surface 1724 of the body of the electronic device 1700. The electronic device is positioned in a center or middle of the hemi-spherical zones such that sides or boundaries of the zones are equally spaced from a perimeter of the electronic device.

FIG. 17C illustrates the electronic device 1700 with two zones 1730 and 1731 that extend outwardly from one or more surfaces (such as a top or front surface 1734 and bottom or back surface 1736). The zones have a spherical configuration. Further, the zones are layered or positioned adjacent each other. Zone 1730 is adjacent to and extends from one or more surfaces of the electronic device, and zone 1731 is positioned on top of or adjacent zone 1730 such that zone 1730 is between zone 1731 and the body of the electronic device 1700. Zone 1730 is adjacent the surfaces, and zone 1731 is positioned on top of or adjacent zone 1730 such that zone 1730 is between zone 1731 and the body of the electronic device 1700. The electronic device is positioned in a center or middle of the spherical zones such that sides or boundaries of the zones are equally spaced from a perimeter of the electronic device.

FIG. 17D illustrates the electronic device 1700 with two zones 1740 and 1741. Zone 1740 extends outwardly from one surface 1744 (such as a top or front surface), and zone 1741 extends outwardly from another surface 1746 (such as a bottom or back surface that is oppositely disposed from the front surface). The zones have a 3D rectangular or square configuration that emulates a rectangular or square configuration of a body of the electronic device 1700.

FIG. 17E illustrates the electronic device 1700 with four zones 1750, 1751, 1752, and 1753. Zones 1750 and 1751 extend outwardly from one surface 1754 (such as a top or front surface), and zones 1752 and 1753 extend outwardly from another surface 1756 (such as a bottom or back surface that is oppositely disposed from the front surface). The zones have a 3D rectangular or square configuration. Further, the zones are positioned adjacent each other such that each zone extends over or adjacent to a different portion of a surface area of the electronic device. Zone 1750 is adjacent to and extends from a first portion of surface 1754; zone 1751 is adjacent to and extends from a second portion of surface 1754; zone 1752 is adjacent to and extends from a first portion of surface 1756; and zone 1753 is adjacent to and extends from a second portion of surface 1756.

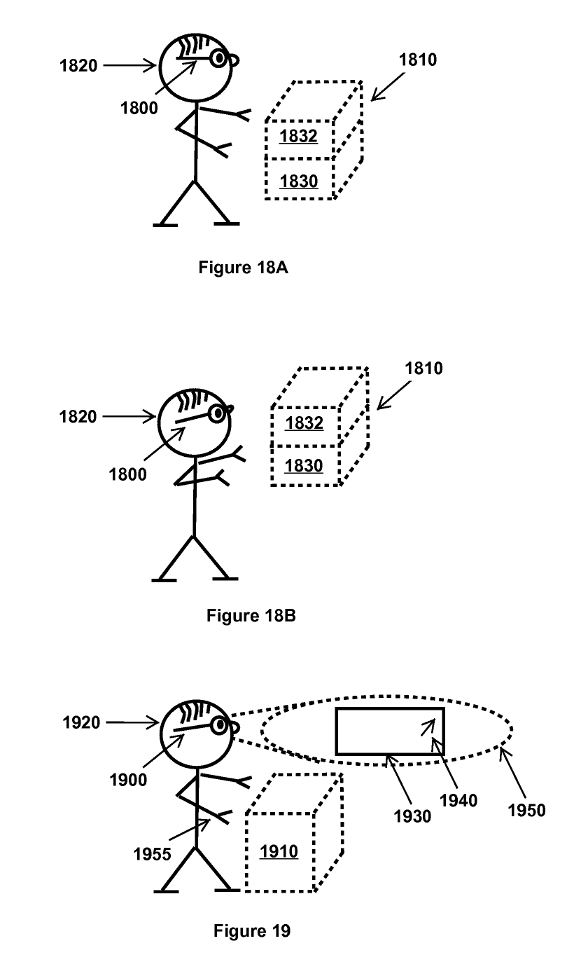

FIGS. 18A and 18B illustrate a wearable electronic device 1800 that provides one or more zones 1810 that control the wearable electronic device 1800 via a touchless user interface. A user 1820 wears the wearable electronic device 1800 that displays, projects, and/or provides the zones 1810 to the user.

FIG. 18A shows two zones 1830 and 1832 vertically stacked on top of each other. These zones exist in an area or space in front of or adjacent to a body of the user such that arms and/or hands of the user interact in the zones to control the wearable electronic device 1800 and/or another electronic device (such as controlling a remote electronic device). For example, zone 1830 is used for typing characters (such as typing into a virtual keyboard), and zone 1832 is used for opening and closing software applications, selecting and dragging objects, navigating on the Internet, etc. Thus, zones 1830 and 1832 perform different functions with regard to the touchless user interface. Further, one zone can be designated to sense and/or interact with one hand and/or arm (such as a left hand of a user), and another zone can be designated to sense and/or interact with another hand and/or arm (such as a right hand of a user).

FIG. 18B shows that the two zones 1830 and 1832 move with respect to the user 1820 and/or the wearable electronic device 1800. For example, when the user 1820 looks upward, the zones 1830 and 1832 move such that the zones remain in the field of vision of the user. When a user has a gaze or line-of-sight to a left side of his body, then the zones appear in this line-of-sight to the left side of the body. When the user changes this gaze or line-of-sight to a right side of his body then the zones appear in this line-of-sight to the right side of the body. The zones track and/or follow a gaze and/or line-of-sight of the user. The user can continue to interact with the zones and the touchless user interface while moving his head about.

In another example embodiment, the zones remain in a fixed position such that they do not follow a gaze or line-of-sight of a user. For example, the zones remain in a fixed position in front of a body of a user (such as displayed or projected in front of a face of a user). When a user looks away from a location of the zones, then the zones disappear.

Consider an example in which the zones appear in front of a user in an area adjacent to a chest and face of the user. The zones appear while the user looks forward and disappear when the user looks away from the zones (such as the zones disappearing when the user looks to his left, looks to his right, looks upward, or looks downward).

FIG. 19 illustrate a wearable electronic device 1900 that provides a zone 1910 that controls the wearable electronic device 1900 via a touchless user interface. A user 1920 wears the wearable electronic device 1900 that displays, projects, and/or provides a display 1930 with a pointing device 1940 that is in a line-of-sight 1950 of the user 1920. One or more hands 1955 of the user 1920 interact with the zone 1910 to control the wearable electronic device 1900 and pointing device 1940. The one or more hands 1950 and the zone 1910 are not located in the line-of-sight 1950 of the user while the user controls the wearable electronic device and/or pointing device via the touchless user interface.

Zones provide areas in space that perform one or more functions, such as, but not limited to, determining clicking or selection operations, tracking hand/or fingers to control a pointing device, determining instructions and/or commands to control the electronic device, and performing other functions described herein. The zones can have predetermined and/or fixed sizes and shapes. For example, a zone can extend or exist in space to have a specific, distinct, and/or predetermined size (e.g., length, width, and height) and a specific and/or predetermined shape (e.g., circular, square, triangular, polygon, rectangular, polyhedron, prism, cylinder, cone, pyramid, sphere, etc.). Zones can exist in distinct predefined 3D areas, as opposed to extending to indefinite or random locations in space. For example, a zone encompasses an area of a cube with a predetermined Length×Width×Height, but does not exist outside of this cube and/or does not receive instructions outside of this cube. As another example, a zone encompasses an area that approximates a shape of a polyhedron. For instance, gesture-based finger and/or hand instructions that occur within a cube control the electronic device via the touchless user interface, and gesture-based finger and/or hand instructions that occur outside of the cube are ignored. Furthermore, zones can be designated with predetermined functions (e.g., one zone designated for tapping; one zone designated for finger gestures; one zone designated for cursor control; one zone designated for control of a software application; etc.). Further yet, an electronic device can have different zone configurations. For example, an electronic device has different zone configurations (such as configurations of FIGS. 17A-17E) that a user selects for his or her device.

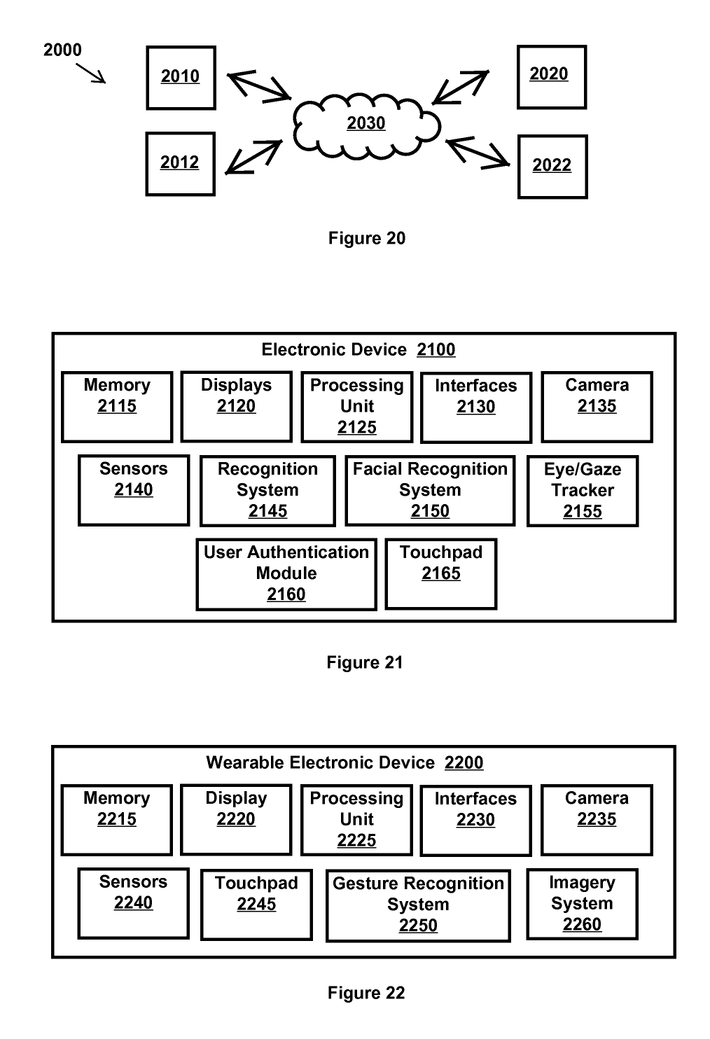

FIG. 20 illustrates a computer system 2000 that includes a plurality of electronic devices 2010 and 2012 and a plurality of servers 2020 and 2022 that communicate with each other over one or more networks 2030.

By way of example, electronic devices include, but are not limited to, handheld portable electronic devices (HPEDs), wearable electronic glasses, watches, wearable electronic devices, portable electronic devices, computing devices, electronic devices with cellular or mobile phone capabilities, digital cameras, desktop computers, servers, portable computers (such as tablet and notebook computers), handheld audio playing devices (example, handheld devices for downloading and playing music and videos), personal digital assistants (PDAs), combinations of these devices, devices with a processor or processing unit and a memory, and other portable and non-portable electronic devices and systems.

FIG. 21 is an electronic device 2100 that includes one or more components of computer readable medium (CRM) or memory 2115, one or more displays 2120, a processing unit 2125, one or more interfaces 2130 (such as a network interface, a graphical user interface, a natural language user interface, a natural user interface, a reality user interface, a kinetic user interface, touchless user interface, an augmented reality user interface, and/or an interface that combines reality and virtuality), a camera 2135, one or more sensors 2140 (such as micro-electro-mechanical systems sensor, a biometric sensor, an optical sensor, radio-frequency identification sensor, a global positioning satellite (GPS) sensor, a solid state compass, gyroscope, and/or an accelerometer), a recognition system 2145 (such as speech recognition system or a motion or gesture recognition system), a facial recognition system 2150, eye and/or gaze tracker 2155, a user authentication module 2160, and a touchpad 2165. The sensors can further include motion detectors (such as sensors that detect motion with one or more of infrared, optics, radio frequency energy, sound, vibration, and magnetism).

FIG. 22 illustrates a pair of wearable electronic glasses 2200 that include one or more components of a memory 2215, an optical head mounted display 2220, a processing unit 2225, one or more interfaces 2230, a camera 2235, sensors 2240 (including one or more of a light sensor, a magnetometer, a gyroscope, and an accelerometer), a gesture recognition system 2250, and an imagery system 2260 (such as an optical projection system, a virtual image display system, virtual augmented reality system, and/or a spatial augmented reality system). By way of example, the augmented reality system uses one or more of image registration, computer vision, and/or video tracking to supplement and/or change real objects and/or a view of the physical, real world.

FIGS. 21 and 22 shows example electronic devices with various components. One or more of these components can be distributed or included in various electronic devices, such as some components being included in an HPED, some components being included in a server, some components being included in storage accessible over the Internet, some components being in an imagery system, some components being in wearable electronic devices, and some components being in various different electronic devices that are spread across a network or a cloud, etc.

The processor unit includes a processor (such as a central processing unit, CPU, microprocessor, application-specific integrated circuit (ASIC), etc.) for controlling the overall operation of memory (such as random access memory (RAM) for temporary data storage, read only memory (ROM) for permanent data storage, and firmware). The processing unit communicates with memory and performs operations and tasks that implement one or more blocks of the flow diagrams discussed herein. The memory, for example, stores applications, data, programs, algorithms (including software to implement or assist in implementing example embodiments) and other data.

Blocks and/or methods discussed herein can be executed and/or made by a user, a user agent of a user, a software application, an electronic device, a computer, a computer system, and/or an intelligent personal assistant.

As used herein, a “drag and drop” is an action in which a pointing device selects or grabs a virtual object and moves or drags this virtual object to a different location or onto another virtual object. For example, in a graphical user interface (GUI), a pointer moves to a virtual object to select the object; the object moves with the pointer; and the pointer releases the object at a different location.

As used herein, the term “face-down” means not presented for view to a user.

As used herein, the term “face-up” means presented for view to a user.

As used herein, a “touchless user interface” is an interface that commands an electronic device with body motion without physically touching a keyboard, mouse, or screen.

As used herein, a “wearable electronic device” is a portable electronic device that is worn on or attached to a person. Examples of such devices include, but are not limited to, electronic watches, electronic necklaces, electronic clothing, head-mounted displays, electronic eyeglasses or eye wear (such as glasses in which augmented reality imagery is projected through or reflected off a surface of a lens), electronic contact lenses (such as bionic contact lenses that enable augmented reality imagery), an eyetap, handheld displays that affix to a hand or wrist or arm (such as a handheld display with augmented reality imagery), and HPEDs that attach to or affix to a person.

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

Method blocks discussed herein can be automated and executed by a computer, computer system, user agent, and/or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

What is claimed is:

1. A non-transitory computer readable storage medium storing instructions that cause a handheld portable electronic device (HPED) to execute a method, comprising:
display a cursor and an object on a display that is located on a first side of a body of the HPED;
sense repetitive circular movements of a finger of a user holding the HPED while the finger is hidden under the body and not visible to the user and is located next to but not touching a second side of the HPED that is opposite to the first side when the first side is visible to the user and the second side is not visible to the user; and
move the cursor along the display in response to the repetitive circular movements of the finger next to but not touching the second side when the first side is visible to the user and the second side is not visible to the user.

2. The non-transitory computer readable storage medium storing instructions of claim 1 further to cause the handheld portable electronic device to execute the method comprising:
provide a three dimensional zone that extends outwardly from a surface of the HPED such that an area inside of the zone provides a touchless user interface to communicate with the HPED;
increase an intensity of color of the zone when the finger of the user physically enters the zone to communicate with the HPED via a touchless user interface;
decrease the intensity of the color of the zone when the finger of the user physically leaves the zone.

3. The non-transitory computer readable storage medium storing instructions of claim 1 further to cause the handheld portable electronic device to execute the method comprising:
sense a tap from the finger at a first location on the second side when the first side is visible to the user and the second side is not visible to the user;
sense a drag of the finger from the first location on the second side to a second location on the second side when the first side is visible to the user and the second side is not visible to the user;
sense removal of the finger at the second location when the first side is visible to the user and the second side is not visible to the user;
activate a click of the cursor on the display on the first side at a location that is oppositely disposed the second location on the second side in response to sensing removal of the finger at the second location.

4. The non-transitory computer readable storage medium storing instructions of claim 1 further to cause the handheld portable electronic device to execute the method comprising:
sense a hand of the user gripping the HPED with fingers at locations along a perimeter of the body;
save on and off activation of a touchless user interface that controls the cursor at the locations where the fingers touch along the perimeter of the body;
activate the touchless user interface in response to sensing the fingers of the user at the locations along the perimeter of the body.

5. The non-transitory computer readable storage medium storing instructions of claim 1 further to cause the handheld portable electronic device to execute the method comprising:
sense a thumb above the display and an index finger below the display such that the index finger is directly below the thumb with the cursor appearing on the display between the thumb and the index finger such that a line perpendicular to the display extends through the thumb, the cursor, and the index finger;
move the cursor along the display in response to sensing simultaneous movements of the thumb and the index finger such that the cursor remains between the thumb and the index finger along the line that extends through the thumb, the cursor, and the index finger.

6. The non-transitory computer readable storage medium storing instructions of claim 1 further to cause the handheld portable electronic device to execute the method comprising:
sense the finger drawing a shape through space adjacent to the second side without the finger touching the second side when the first side is visible to the user and the second side is not visible to the user;
determine a software application that is associated with the shape drawn through the space;
open the software application in response to sensing the finger drawing the shape through the space adjacent to the second side and without touching the second side when the first side is visible to the user and the second side is not visible to the user, wherein the user decides what configuration to draw through space as the shape.

7. The non-transitory computer readable storage medium storing instructions of claim 1 further to cause the handheld portable electronic device to execute the method comprising:
sense the finger moving through space adjacent to the second side and without touching the second side when the first side is visible to the user and the second side and the finger are not visible to the user;
execute a drag and drop operation on the object in response to the finger moving through the space adjacent to the second side and without touching the second side when the first side is visible to the user and the second side and the finger are not visible to the user.

8. The non-transitory computer readable storage medium storing instructions of claim 1 further to cause the handheld portable electronic device to execute the method comprising:
activate the display on the first side and deactivate a second display on the second side in response to sensing that the first side is face-up and visible to the user and the second side is face-down and not visible to the user;
sense a flipping of the HPED such that the second side is face-up and visible to the user and first side is face-down and not visible to the user;
activate the second display on the second side and deactivate the display on the first side in response to sensing the flipping of the HPED such that the second side is face-up and visible to the user and first side is face-down and not visible to the user.

9. A handheld portable electronic device (HPED), comprising:
a body that has a rectangular shape with a first side and a second side oppositely disposed from the first side;
a sensor that senses a finger of a user with respect to a location on the second side when the finger is proximate to but not touching the location on the second side and that senses movement of the finger towards the location on the second side while the first side is face-up and visible to the user and the second side is face-down and not visible to the user;
a display that is located on the first side, that displays an object, and that displays a cursor at a location that is oppositely disposed from and directly over the location of the finger on the second side while the finger is proximate to but not touching the location on the second side; and
a processor that communicates with the sensor and with the display and that activates, in response to the sensor sensing movement of the finger toward the location on the second side, a click on the object on the display such that the click activates on the object without the finger touching the second side while the first side and display are face-up and visible to a user and the second side is face-down and not visible to the user.

10. The handheld portable electronic device of claim 9 further comprising:
a touchless user interface that extends outwardly from the first side to form a three dimensional zone with a cubic shape that receives gestures from the finger to instruct the HPED, wherein the display displays an image of the three dimensional zone and a location of the finger in the image of the three dimensional zone when the finger is physically located in the three dimensional zone that extends outwardly from the first side.

11. The handheld portable electronic device of claim 9, wherein the sensor senses movement of the finger along a distance that is parallel to the second side while the finger is proximate to but not touching the second side and while the first side and display are face-up and visible to a user and the second side is face-down and not visible to the user, and wherein the processor communicates with the display to move the cursor on the display along a distance that is equal to the distance that the finger moved parallel to the second side while the first side and display are face-up and visible to a user and the second side is face-down and not visible to the user.

12. The handheld portable electronic device of claim 9 further comprising:
a second sensor that senses the finger of the user with respect to the first side when the finger is proximate to but not touching a location on the first side and that senses movement of the finger towards the location on the first side while the second side is face-up and visible to the user and the first side is face-down and not visible to the user;
a second display that is located on the second side, that displays the object, and that displays the cursor at a location that is oppositely disposed from and directly over the location of the finger on the first side while the finger is proximate to but not touching the location on the first side; and
wherein the processor communicates with the second sensor and with the second display and that activates, in response to the second sensor sensing movement of the finger toward the location on the first side, a second click on the object on the second display such that the second click activates on the object without the finger touching the first side while the second side and the second display are face-up and visible to a user and the first side and the display are face-down and not visible to the user.

13. The handheld portable electronic device of claim 9 further comprising:
a second display that is located on the second side;
wherein the display on the first side activates to display a configuration of icons and the second display on the second side de-activates to black screen while the first side and the display are face-up and visible to the user and the second side and the second display are face-down and not visible to the user; and
wherein the second display on the second side activates to display the configuration of icons and the display on the first side de-activates to black screen after the HPED is flipped such that the second side and the second display are face-up and visible to the user and the first side and the display are face-down and not visible to the user.

14. The handheld portable electronic device of claim 9 further comprising:
a biometric sensor that examines a fingerprint on the finger in order to authenticate an identity of the user every time the finger moves with respect to the second side to control the cursor on the display when the finger is proximate to but not touching the second side.

15. A method, comprising:
displaying an object on a display located at a first surface of a handheld portable electronic device (HPED);
sensing, by the HPED, a tap from a finger of a user at a first location on a second surface that is oppositely disposed from the first surface while the first surface and display are face-up and visible to the user and the second surface is face-down and not visible to the user;
sensing, by the HPED, drag movement of the finger along the second surface from the first location to a second location that is oppositely disposed from and directly under the object on the display while the first surface and display are face-up and visible to the user and the second surface is face-down and not visible to the user;
sensing, by the HPED, removal of the finger from second surface at the second location upon completion of the drag movement while the first surface and display are face-up and visible to the user and the second surface is face-down and not visible to the user; and
activating, by the HPED, a click on the object on the display in response to sensing removal of the finger from second surface at the second location upon completion of the drag movement.

16. The method of claim 15 further comprising:
sensing repetitive motion of the finger along a looped path in space that begins at a first point above the second surface, proceeds a distance parallel to the second surface to a second point, moves away from the second surface to third point, and moves toward the second surface to loop back to the first point while the finger is proximate to but not touching the second surface and while the first surface and display are face-up and visible to the user and the second surface is face-down and not visible to the user;
moving a cursor on the display a distance that equals the distance between the first point and second point times a number of repetitive motions of the finger along the looped path while the finger is proximate to but not touching the second surface and while the first surface and display are face-up and visible to the user and the second surface is face-down and not visible to the user.

17. The method of claim 15 further comprising:
sensing a first hand of the user with fingers in a predetermined configuration while the first hand is located away from a body of the HPED and not touching the body of the HPED;
activating a touchless user interface in response to sensing the first hand of the user with the fingers in the predetermined configuration while the first hand is located away from the body of the HPED and not touching the body of the HPED;
sensing a second hand of the user moving to instruct the HPED via the touchless user interface while the first hand of the user and the fingers remain in the predetermined configuration while the first hand is located away from the body of the HPED and not touching the body of the HPED;
wherein the touchless user interface remains active while the first hand of the user and the fingers remain in the predetermined configuration while the first hand is located away from the body of the HPED and not touching the body of the HPED.

18. The method of claim 15 further comprising:
sensing movement of the finger along a Z-axis toward the HPED;
initiating a click on an object in response to sensing movement of the finger along the Z-axis toward the HPED;
sensing movement of the finger along the Z-axis away from the HPED;
initiating a release of the click on the object in response to sensing movement of the finger along the Z-axis away from the HPED.

19. The method of claim 15 further comprising:
sensing a hand holding the HPED at a designated location along a perimeter of a body of the HPED;
activating touchless movement and touchless clicking of a cursor on the display in response to sensing the hand holding the HPED at the designated location along the perimeter of the body of the HPED;
sensing removal of the hand holding the HPED at the designated location along the perimeter of the body of the HPED;
de-activating the touchless movement and the touchless clicking of the cursor in response to sensing removal of the hand holding the HPED at the designated location along the perimeter of the body of the HPED.

20. The method of claim 15 further comprising:
sensing movement of the finger along a curved path that is parallel to the second surface while the finger is proximate to but not touching the second surface and while the first surface and display are face-up and visible to the user and the second surface is face-down and not visible to the user;
moving a cursor on the display along a curved path that emulates the curved path of the finger to the second surface while the finger is proximate to but not touching the second surface and while the first surface and display are face-up and visible to the user and the second surface is face-down and not visible to the user.
